(19) United States
(12) Patent Application Publication
(10) Pub. No.: US 2016/0189106 A1
(43) Pub. Date: Jun. 30, 2016

(54) PLAN ANALYSIS SERVER SYSTEM AND METHOD

(71) Applicant: THE PRINCIPAL FINANCIAL GROUP, Des Moines, IA (US)

(72) Inventors: Scott Fraungruber, Grand Rapids, MI (US); Ryan Rippin, Urbandale, IA (US); Julie Pewe, Johnston, IA (US); Thao Pham, Urbandale, IA (US); Kurt Zimmerman, Waukee, IA (US); Skyler Burmeister, Elkhorn, NE (US); Dawn Mather, Huxley, IA (US)

(21) Appl. No.: 14/971,568

(22) Filed: Dec. 16, 2015

Related U.S. Application Data
(60) Provisional application No. 62/092,691, filed on Dec. 16, 2014.

(51) Int. Cl. G06Q 10/10; G06Q 10/06

(52) U.S. Cl. CPC G06Q 10/1057; G06Q 10/06312

(57) ABSTRACT

Some embodiments include a plan analysis server system with a computing device that couples to a back-end database server including current plan data, and calculates an eligible employee total by counting the number of employees records in the current plan data. The operations also include totaling a plan asset size by summing account balances for all eligible employees, determining employees with non-zero deferral from the current plan data, and calculating a current participation rate by calculating the percentage of eligible employees with non-zero deferral. The current plan is displayed in a primary window as selected by the user from user input. The processor optionally processes a scenario display utilizing the eligible employee data and administrator input. The at least one scenario display is displayed as one or more layers on the current plan data and displayed in the primary window as selected by the user from the user input.

### RELATED APPLICATIONS

This application claims priority from Provisional Application No. 62/092,691, filed on Dec. 16, 2014, entitled “Plan analysis server system and method”, the entire contents of which are incorporated herein by reference.

### BACKGROUND

Employers face ongoing challenges attempting to increase the retirement readiness of their employees. While the advantages of many benefit plans are undisputed, many employees still fail to take advantage of such plans. Currently, benefit providers, consultants and plan advisers have difficulty modeling how changes to an employer's current benefit plans can impact employee participation and retirement readiness.

### SUMMARY

Some embodiments include a plan analysis server system comprising at least one computing device comprising at least one processor a non-transitory computer readable medium, having stored thereon, instructions that when executed by the at least one computing device, cause the at least one computing device to perform operations. The operations include coupling to a back-end database server comprising current plan data, and calculating an eligible employee total by counting the number of employee records in the current plan data. The operations also include totaling a plan asset size by summing account balances for all eligible employees, determining employees with non-zero deferral from the current plan data, and calculating a current participation rate by calculating the percentage of eligible employees with non-zero deferral.

The operations include processing and displaying at least one current plan utilizing eligible employee data and administrator input. The at least one current plan is displayed in a primary window as selected by the user from user input. The display optionally includes an average account balance, and/or a current participation rate, and/or an average deferral percentage, and/or an average matching percentage. Further, the at least one processor calculates the average account balance by dividing the total number of eligible employees by the current participation rate. The processor calculates the average deferral percentage by accessing the plan records of all eligible employees and calculates the average percentage of income that employees in the current plan are deferring by summing the deferrals of all eligible employees and dividing by the total number of eligible employees. The at least one processor calculates the average matching percentage by base on one or more tier match percentages and tier limits. The processor optionally processes at least one scenario display utilizing the eligible employee data and administrator input. The at least one scenario display is displayed as one or more layers on the current plan data and displayed in the primary window as selected by the user from the user input. The scenario display optionally includes the average account balance, and/or the current participation rate, and/or the average deferral percentage, and/or the average matching percentage. Further, the average account balance, the current participation rate, the average deferral percentage, and the average matching percentage can deviate from the current plan based on user input.

In some embodiments, the average matching percentage is calculating by multiplying a tier 1 match percentage by the smaller of either the employee deferral percentage or a tier 1 limit. If there is a tier 2 match, the at least one processor multiplies the tier 2 match percentage by the smaller of either the remaining employee deferral percentage or the tier 2 limit, and adds the value to the tier 1 matching percentage If there is a tier 3 match, the at least one processor multiplies the tier 3 match percentage by the smaller of either the remaining employee deferral percentage or the tier 3 limit, and adds the value to the tier 2 matching percentage, and calculates the average by summing a matching percentage payable to all eligible employees and dividing the value by the total number of eligible employees.

In some embodiments, any one of the average account balance, a current participation rate, an average deferral percentage, and an average matching percentage can be displayed in a secondary window at least partially overlapping the primary window. In some embodiments, at least one of the brightness, contrast, and color of at least a portion of the primary window can be at least partially darkened when the secondary window is displayed over the primary window.

In some embodiments, the percentage of eligible employees is displayed in at least one bar chart. In some embodiments, the at least one bar chart comprises eligible employees as a function of age or age range. In some further embodiments, the at least one bar chart comprises eligible employees as a function of salary or salary range.

In some embodiments, the average employee contribution is displayed in at least one bar chart. In some embodiments, the at least one bar chart comprises average employee contribution as a function of age or age range. In some embodiments, the at least one bar chart comprises average employee contribution as a function of salary or salary range.

In some embodiments, the user input is selectable or entered on the scenario display and includes at least one of an employee contribution auto-enrollment entry option, an employee contribution auto-escalate entry option, and a matching contribution value entry option.

In some embodiments of the invention, upon a user input to any one of the employee contribution auto-enrollment entry option, an employee contribution auto-escalate entry option, or matching contribution value entry option, the at least one processor dynamically updates the scenarios display.

### DESCRIPTION OF THE DRAWINGS

FIG. 1 illustrates a screen shot of a data uploading portion of a plan analysis server system and method according to one embodiment of the invention.

FIGS. 2A-2B and 3A-3B show screen shots of a user administration portion of a plan analysis server system and method according to one embodiment of the invention.

FIGS. 4A-4B show screen shots of the present screen portion of a plan analysis server system and method according to one embodiment of the invention.

FIGS. 5A-5C show screen shots of the current plan data portion of a plan analysis server system and method according to one embodiment of the invention.

FIG. 6 illustrates the beginning portion of a presentation of a plan analysis server system and method according to one embodiment of the invention.

FIGS. 7A and 7B illustrate the percentage of employees on track of a plan analysis server system and method according to one embodiment of the invention.

FIG. 8 shows a summary screen of a plan analysis server system and method according to one embodiment of the invention.

FIGS. 9A and 9B show modeling functionality for a user to change parameters and updated results of a plan analysis server system and method according to one embodiment of the invention.

FIGS. 10A-10B shows how changes in selected metrics can be summarized and a summary for the increase in employees of a plan analysis server system and method according to one embodiment of the invention.

FIGS. 11A-11B show how changes in selected metrics can be summarized in the current plan's average employee contribution of a plan analysis server system and method according to one embodiment of the invention.

FIG. 12 shows how changes in selected metrics can impact a plan's average employee contribution by salary according to one embodiment of the invention.

FIGS. 13A-13B show how changes in selected metrics can impact a plan's average employee contribution over three years according to one embodiment of the invention.

FIGS. 14A-14B shows how changes in employer matching can impact a plan's average employee contribution according to one embodiment of the invention.

FIG. 15 shows how changes in automatic enrollment can impact a plan's average employee saving rate and opt-out rate according to one embodiment of the invention.

FIG. 16 shows how automatic escalation can impact a plan's average employee contribution according to one embodiment of the invention.

FIG. 17 shows how employer matching can impact a plan's average employee contribution by salary according to one embodiment of the invention.

FIG. 18 shows how modeled plan changes can impact a plan's number of employees on track for retirement according to one embodiment of the invention.

FIG. 19 shows summaries of selected parameters of a proposed plan according to one embodiment of the invention.

FIG. 20 shows an overview of information flow according to one embodiment of the invention.

FIG. 21 shows an overview of a computer infrastructure for a plan analysis server system and method according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

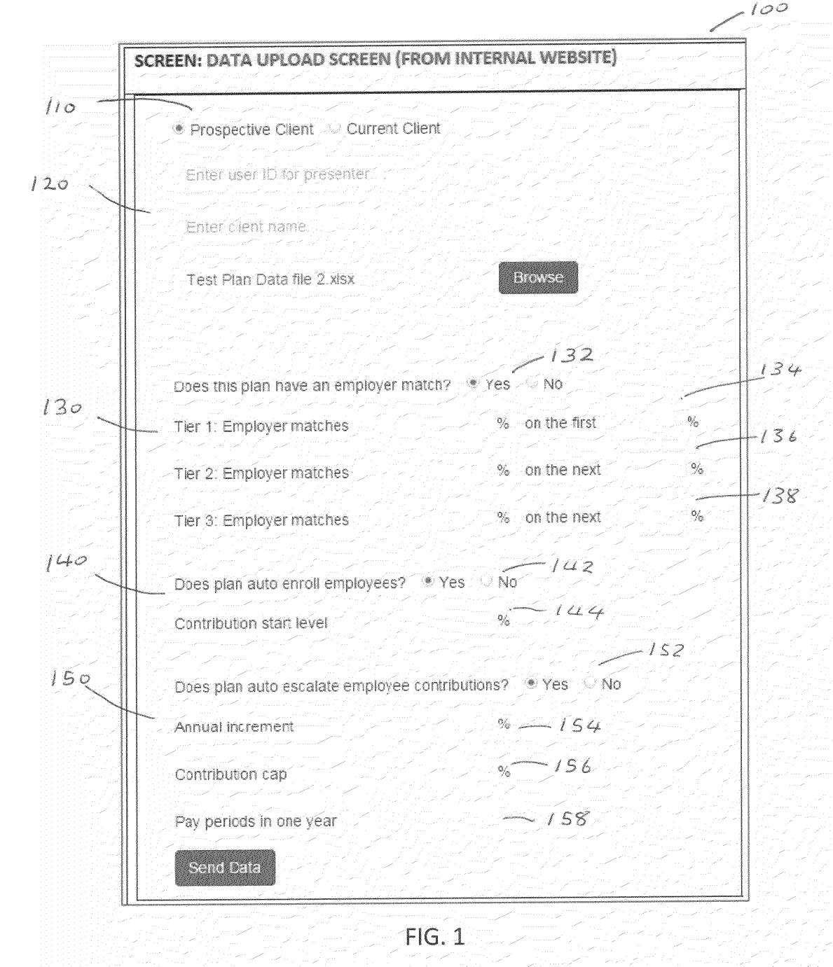

Some embodiments provide a plan analysis server system and method which enables the uploading and downloading of employer-specific plan data and enables modeling of different benefit parameter changes and their impact on employee retirement readiness. Some embodiments of the invention include a computer-implemented plan analysis server system and method for modeling benefit parameter changes and displaying the modeling results in a readily understood format. Some embodiments of the invention include a non-transitory computer-readable medium having instructions executed by a processor to perform a plan analysis server system and method. Some embodiments of the invention can include a plan analysis server system and method. For example, FIG. 1 illustrates a data upload screen 100 according to one embodiment of the invention. In some embodiments, the data upload screen 100 can provide an interface for a user to upload information related to an employer and the employer's benefit plans. Some embodiments enable the employee to browse available files for uploading or to enter data file information. In some embodiments of the invention, the data upload screen 100 the can enable identification of a current client or a prospective client. In some embodiments, using a toggle 110, a user can switch entry fields 120 between prospective and current client entries. Some embodiments include entry of information relating to the employer's matching percentages and tiers of matches of retirement contributions if applicable. For example, match fields 130 can comprise at least one tier employee match, and an employer match selection that can be updated using the toggle 132. The matching percentage and the percentage of contribution that is matched can be entered or displayed in at least one set of entry fields. For example, for the three tiers shown in the match fields 130, each tier can include an entry display field for entry and/or display of the matching percentage and the percentage that is matched. For example, some embodiments include percentage match fields 134, percentage match fields 136, and/or percentage match fields 138.

Some embodiments enable entry of automatic enrollment information including contribution start levels, escalations, contribution caps and pay periods in one year. Data can be sent or downloaded to other modules of the plan analysis server system and method as desired. For example, some embodiments relate to automatic enrollment 140. In some embodiments, an auto enrollment toggle 142 can be used to set and indicate automatic enrollment 140. The contribution start level field 144 can be used to enter or display a percentage contribution start level. Some embodiments relate to automatic enrollment escalation 150. For example, some embodiments include escalation toggle 152 that can be used to set and indicate automatic escalation of employee contributions. Variables related to automatic escalation can be displayed in one or more data fields 150 that can related to annual increment (shown as percentage data field 154), contribution cap (shown as percentage data field 156), and pay periods in one year (shown as data field 158). In some embodiments, following review and/or entry of one or more data fields of the data upload screen 100, data can be sent to the plan analysis server system and method.

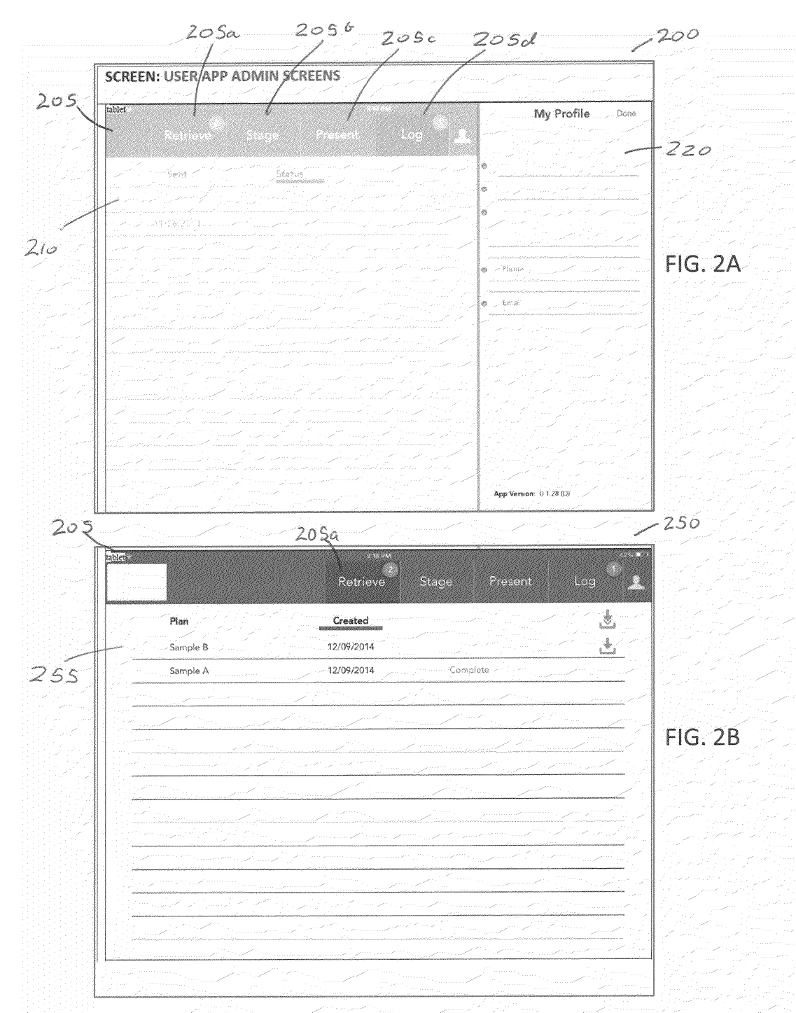

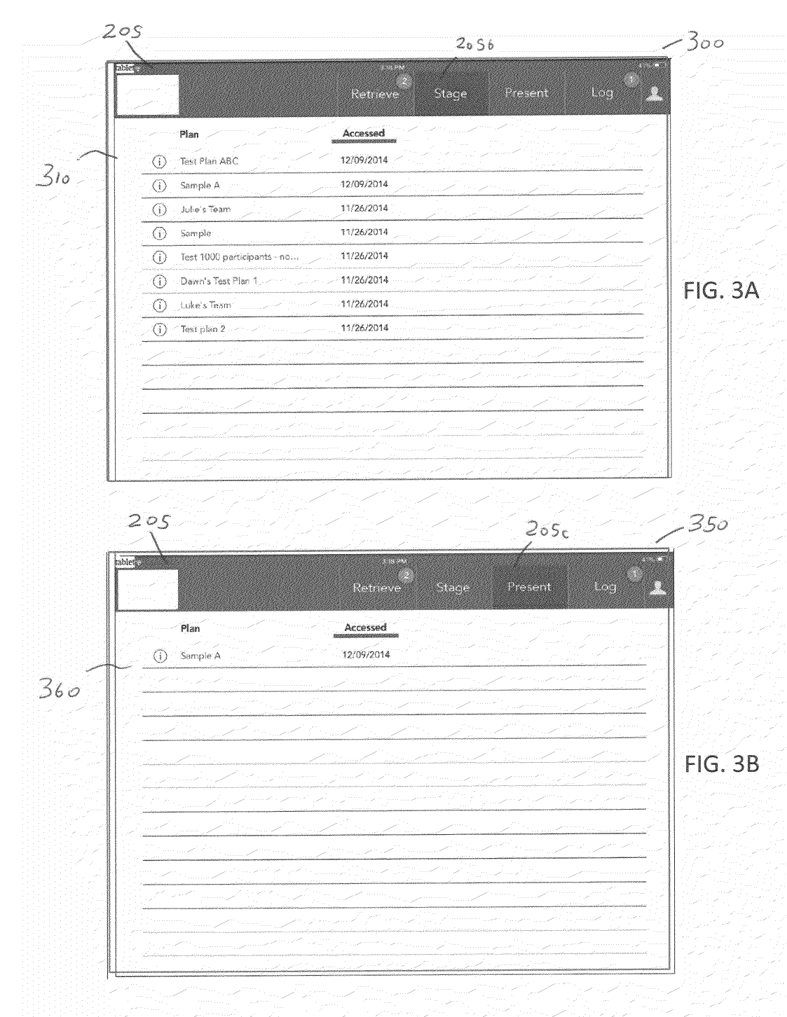

As depicted in FIGS. 2A-2B and 3A-3B, some embodiments of the invention include an administrative function that can enable a user to quickly access and see various portions of the plan analysis server system and method. In some embodiments, by accessing a control bar 205, the portions can include a “Retrieve” portion (shown as tab 205a), a “Stage” portion (shown as tab 205b), a “Present” portion (shown as tab 205c), and/or a “Log” portion (shown as tab 205d). Some embodiments of the Retrieve portion include functionality which enables the user to see the plan data already downloaded, uploaded or sent, retrieve more data, and include user profile information. The data that are downloaded are stored in a computer readable medium on one of a wide variety of computing devices. Such storage is implemented by at least one processor. For example, referring initially to FIG. 2A, some embodiments include an administrative screen 200 including a control bar 205 where a user can access the portions including the “Retrieve” portion (shown as tab 205a), the “Stage” portion (shown as tab 205b), the “Present” portion (shown as tab 205c), and/or the “Log” portion (shown as tab 205d). In some embodiments, once a user selects one or more of the tabs 205a, 205b, 205c, 205d, the plan analysis server system and method can display an information data field 210 that can comprise administrative information related to any of the tabs 205a, 205b, 205c, 205d. Further, in some embodiments, a profile window 220 can be displayed with entry fields for a user's profile.

In some embodiments, an administrative user can use the control bar 205 to access to an information data field 210 within any of the tabs 205a, 205b, 205c, 205d. For example, referring to FIG. 2B, the display screen 250 can include data field 255 that can comprise administrative information related to any of the tabs 205a, 205b, 205c, 205d. In the example shown in FIG. 2B, the information shown in data field 255 comprises information in the selected tab 205a. Further, referring to FIG. 3A, the display screen 300 can include a data field 310 that can comprise administrative information related to any of the tabs 205a, 205b, 205c, 205d. In the example shown in FIG. 3A, the information shown in data field 310 can comprise information in the selected tab 205b.

In some embodiments, the plan analysis server system and method can include a presentation function. This screen enables the user to see the status of plans along with relevant dates. This portion of the interface can help initiate a presentation to a client representative under the command of at least one computer processor executing instructions to retrieve presentation data from a computer readable storage medium. For example, referring to FIG. 3B, the display screen 350 can include a data field 360 that can comprise administrative information related to any of the tabs 205a, 205b, 205c, 205d. In the example shown in FIG. 3B, the information displayed in data field 360 can comprise information in the selected tab 205c (“Present”).

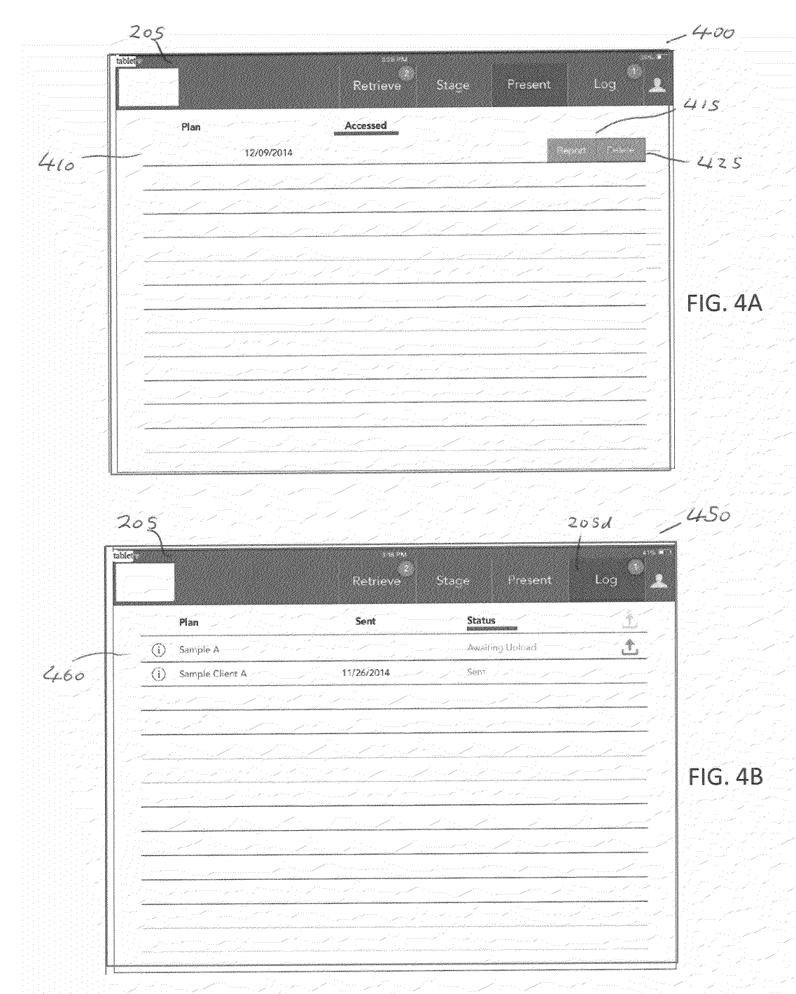

In some embodiments, information can be displayed as a report or deleted from an information field. For example, referring to FIG. 4A, the display screen 400 can include a data field 410 that includes a report function 415 and a delete function 425. In some embodiments, a report can be prepared including any information displayed by the plan analysis server system and method. Further, in some embodiments, an administrative user can utilize the delete function 425 to delete any information or data from the plan analysis server system and method, including any information displayed by accessing any of the tabs 205a, 205b, 205c, 205d. In some embodiments, tab 205d can be used to review, monitor, and/or log information related to any user within the plan analysis server system and method. For example, referring to FIG. 4B, the display screen 450 can include a data field 460 including client records and the current status of the record.

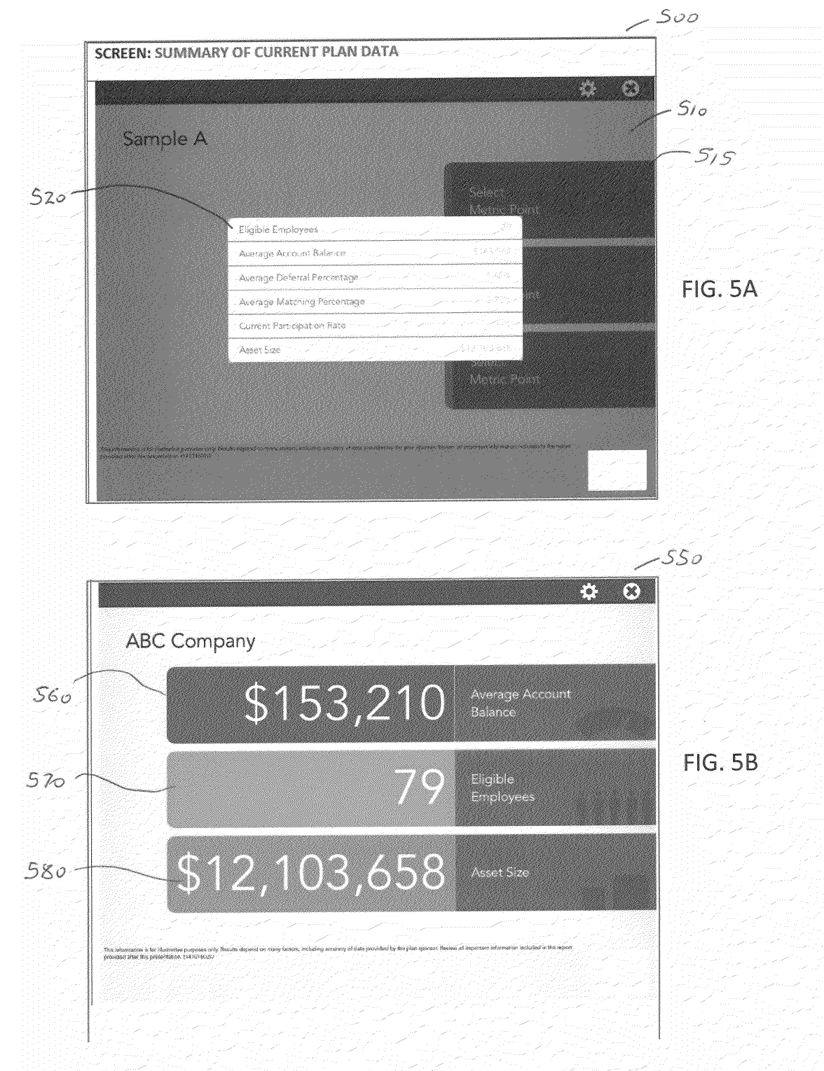

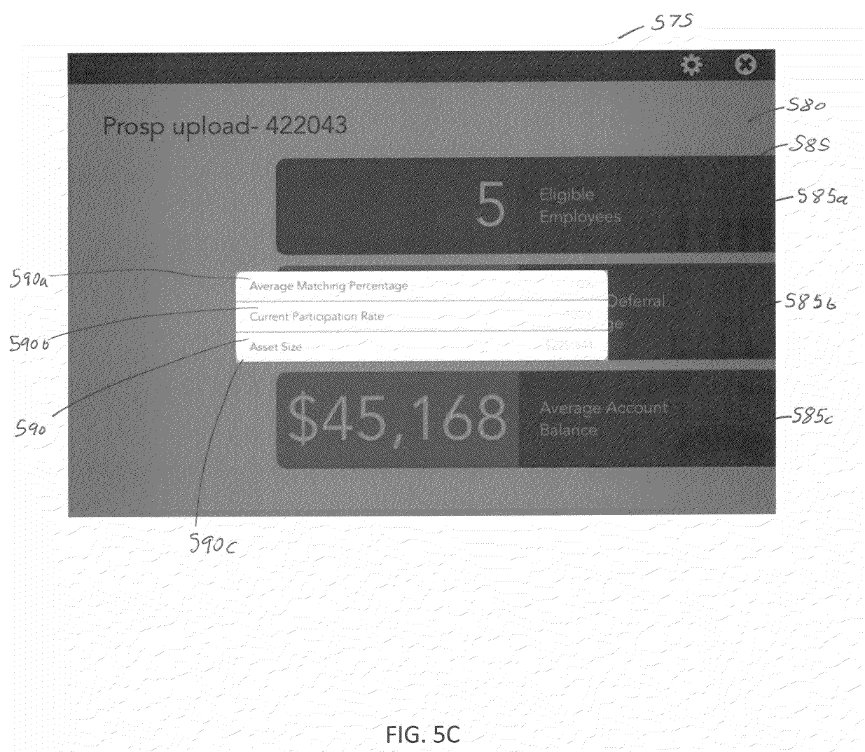

In some embodiments, the plan analysis server system and method can process and display a summary of current plan data including selectable metrics. Some embodiments provide up to six metrics, but more or less metrics can be displayed. The selected metrics can be displayed in the summary form shown in FIG. 5B. For example, referring to FIG. 5A, the display screen 500 can include a information window 510, data fields 515, and overlay window 520 including one or more selectable metrics comprising eligible employees, average account balance, average deferral percentage, average matching percentage, current participation rate, and asset size. Referring to FIG. 5B, in one non-limiting embodiment, the selected metrics are shown in data fields 560, 570, 580 displayed in the summary form 550. Referring to FIG. 5C, the display screen 575 can include an information window 580, with data fields 585 (with metrics displayed including eligible employees 585a, average deferral percentage 585b, average account balance 585c), and an overlay window 590 that can comprise other metrics related to the metric displayed in the underlying data fields 585, including, but non limited to average matching percentage 590a, current participation rate 590b, and/or asset size 590c.

The Eligible Employees 585a can be the number of employees that are eligible to participate in the plan based on plan criteria. This value is calculated by counting the number of employees (i.e., records) in the current plan data. The average deferral percentage 585b is the average percentage of income that employees in the current plan are deferring. To calculate the result, plan analysis server system and method first sums the deferrals of all eligible employees, and then divides that value by the total number of eligible employees. The average account balance 585c represents the average dollar value of the employees' retirement savings to date. This value is the total asset size divided by the total number of eligible employees. The current participation rate 590b is the percentage of eligible employees in a plan that are deferring into the plan. This is calculated by dividing the number of eligible employees that have a non-zero employee deferral percentage by the total number of eligible employees. The asset size 590c is the current total value of the retirement plan across all eligible employees. This value is calculated by adding up the employee account balance for all eligible employees. The average matching percentage 590a is the average percentage of income that the employer is contributing to the eligible employees in the plan, through matching. In performing a matching calculation, first, the plan analysis server system and method calculates the matching percentage for each participating employee by multiplying the tier 1 match percentage by the smaller of either the employee deferral percentage or the tier 1 limit. If there is a tier 2 match, the plan analysis server system and method multiples the tier 2 match percentage by the smaller of either the remaining employee deferral percentage or the tier 2 limit, and adds the value to the tier 1 matching percentage. If there is a tier 3 match, the plan analysis server system and method multiplies the tier 3 match percentage by the smaller of either the remaining employee deferral percentage or the tier 3 limit, and adds the value to the tier 2 matching percentage. The plan analysis server system and method then calculates the average by summing the matching percentage the employer would pay to all eligible employees and divides that value by the total number of eligible employees.

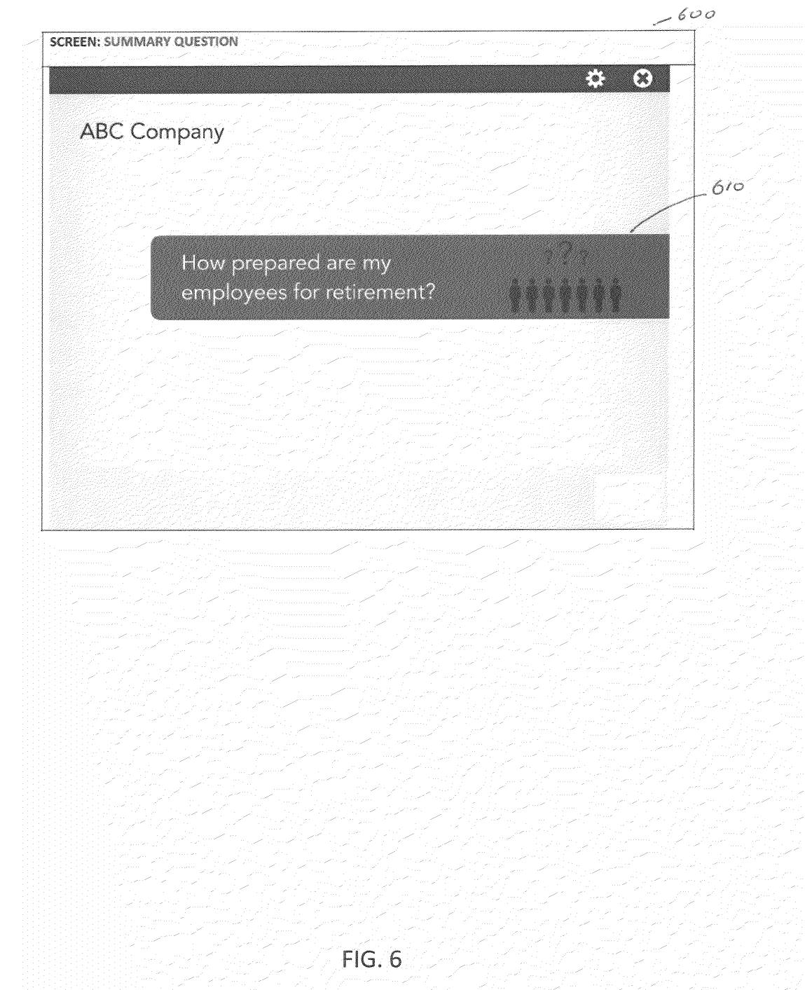

FIG. 6 illustrates a beginning portion of a presentation produced by some embodiments of the plan analysis server system and method. The presentation can be prepared based on multiple scenarios that can be modeled and saved in the Stage portion (shown earlier as shown as tab 205b). Less relevant and/or less impressive data and portions of scenarios can be omitted in the Stage portion in some embodiments. The portion can comprise a summary question display with a question field 610 related to the status of benefits and/or benefits uptake by employees of a client's company.

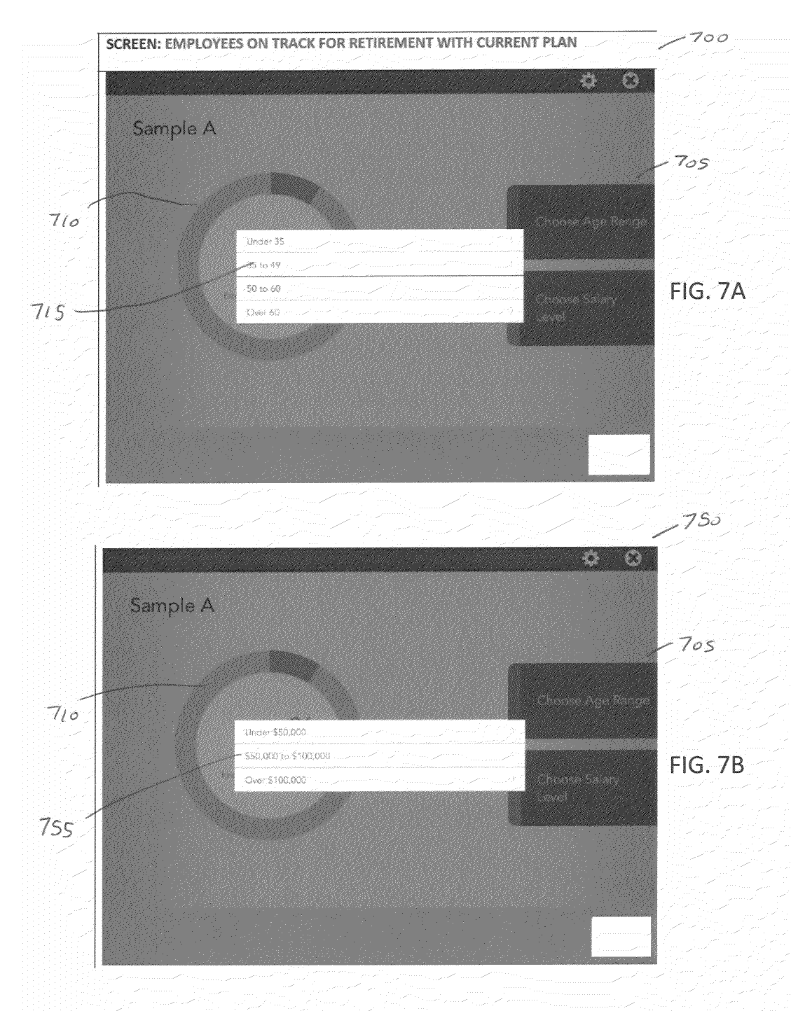

In some embodiments, the plan analysis server system and method can display one or more screens comprising retirement information and statistics of employee's of a client or user's company. For example, the plan analysis server system and method can display various statistics of employees on track for retirement. Different metrics can be selected which can include age ranges, income ranges or other metrics as desired. For example, referring to FIG. 7A with display screen 700, data field selectors 705 can be used to generate or toggle employee statistics or characteristics. Further, graph 710 can be used to display data calculated by the plan analysis server system and method for one or more chosen employee statistics or characteristics, and overlay window 715 can be used to display at least one selectable parameter, range, or characteristic of any specific employee statistics or characteristics of selected using the data field selectors 705. In this example embodiment, the overlay window 715 can comprise a selectable age or age range.

Further, referring to FIG. 7B with display screen 750, data field selectors 705 can be used to generate or toggle employee statistics or characteristics. The graph 710 can be used to display data calculated by the plan analysis server system and method for one or more chosen employee statistics or characteristics, and overlay window 755 can be used to display at least one selectable parameter, range, or characteristic of any specific employee statistics or characteristics of selected using the data field selectors 705. In this example embodiment, the overlay window 755 can comprise a selectable salary level or range.

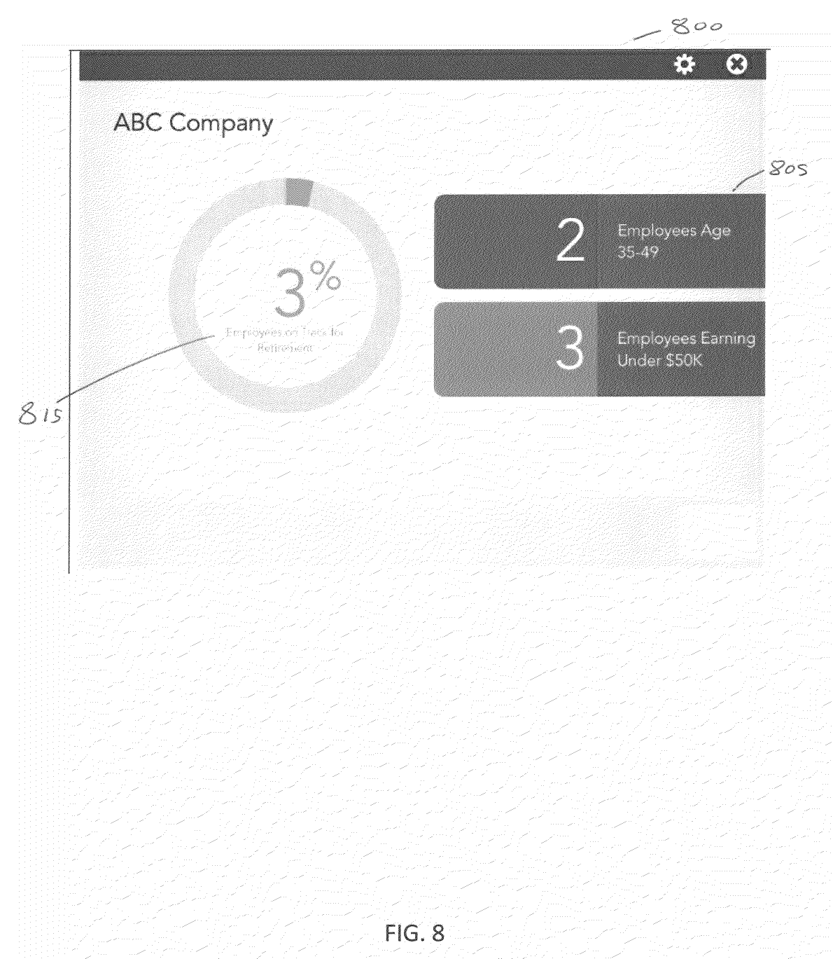

In some embodiments, following a user selection of any parameter or range from an overlay window (e.g., such as overlay windows 715, 755), the plan analysis server system and method can display the selected parameters or ranges, and calculate and display a value related to the number of employees that are on track for retirement. For example, FIG. 8 shows a summary screen 800 populated based on the selections made in the portion of the interface shown in FIGS. 7A and 7B. For example, data fields 805 show selected age and employee salary, and graph 815 comprises the percentage of employees on track for retirement.

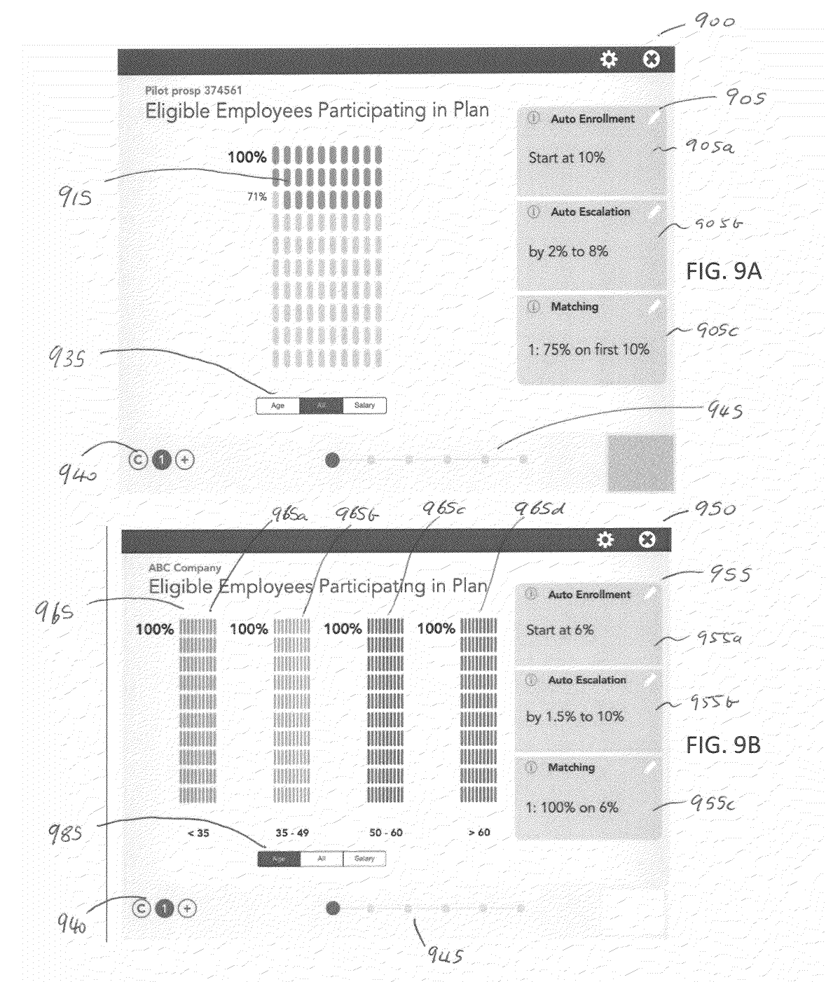

Some embodiments can include modeling functionality that can enable a user to change retirement plan parameters and show updated results in tabulated or graphical form. For example, some parameters can be switched on and off using switch graphics and associated functionality. The modeling functionality can use industry standard data, data privately collected by an employer, data collected by an insurance company or other organization and/or other data as desired. For example, referring to FIG. 9A, the display screen 900 can include data fields 905 comprising one or more selectable retirement plan parameters including single values or ranges. In some embodiments, the data fields 905 can comprise an auto enrollment tab 905a, and/or an auto escalation tab 905b, and/or a matching tab 905c. In some embodiments, any of the tabs 905a, 905b, 905c can comprise a parameter that can be selected or changed by the user to assess the impact on one or more retirement plan statistics.

Various portions or steps of the process can be addressed within the display screen 900 as represented by the step or category indicator 945, and category of functionality can be displayed using the display icon 940. For example, a button labeled “C” can be touched or mouse clicked to display current plan parameters. New models or scenarios can be toggled on with the button labeled “1” and additional models or scenarios can be toggled on with buttons labeled with subsequent numerals. These additional buttons are located to the right of the “1” button in some embodiments. A “+” button enables navigating to a presentation mode in some embodiments. In some embodiments, a series of circles joined by a line enable navigation to other portions of the plan analysis server system and method. Tapping or mouse clicking a circle takes the user to at least one screen corresponding to the other portions.

In some embodiments, a user can review and model data based on employee parameters such as the number of employees participating in a plan. In other embodiments, within another step or category indicator 945, a user can review and model data based on average employee contributions. In some embodiments, following a selection of one or more selectable retirement plan parameters, the plan analysis server system and method can calculate a statistics display 915 based on one or more parameters or ranges shown in the data fields 905. In some further embodiments, the category toggle 935 can be used to toggle an employee parameter for calculating or filtering calculated data shown in the statistics display 915 including, but not limited to, employee age and employee salary. In some embodiments, the category toggle 935 can be used to select all employees without any filtering by age and/or salary, or other filter. In some embodiments, an analysis depicted in FIG. 9A can display eligible employee data based as a function of the employees age. In this instance, the current participation rate is the percentage of all eligible employees in a plan that are deferring into the plan. In some embodiments, any calculated values described herein can be rounded for charting and display purposes.

Referring to FIG. 9B, in some embodiments, a display screen 950 can include data fields 955, and statistics display 965. The data fields 955 can comprise an auto enrollment tab 955a, and/or an auto escalation tab 955b, and/or a matching tab 955c. In some embodiments, any of the tabs 955a, 955b, 955c can comprise a parameter that can be selected or changed by the user to assess the impact on one or more retirement plan statistics. In some embodiments, the category toggle 985 can be used to toggle an employee parameter based on an employees age. In some embodiments, following a selection of one or more selectable retirement plan parameters, the plan analysis server system and method can calculate a statistics display 965 based on one or more parameters or ranges shown in the data fields 955. The current participation rate by age is the percentage of eligible employees within specific age groups that are currently participating in the plan. This is calculated by determining the participation rate for each of four age groups (e.g., under 35, 35 to 49, 50 to 59, and 60 and over). The current participation rate can be calculated by summing the current participating employees in an age group, then dividing the value by the total eligible employees in the age group. In some embodiments, the statistics display 965 can comprise data bar 965a representing data for employees less than 35 years old, data bar 965b representing data for employees between 35 and 49 years old, data bar 965c representing data for employees between 50 and 60 years old, and data bar 965d representing data for employees greater than 60 years old.

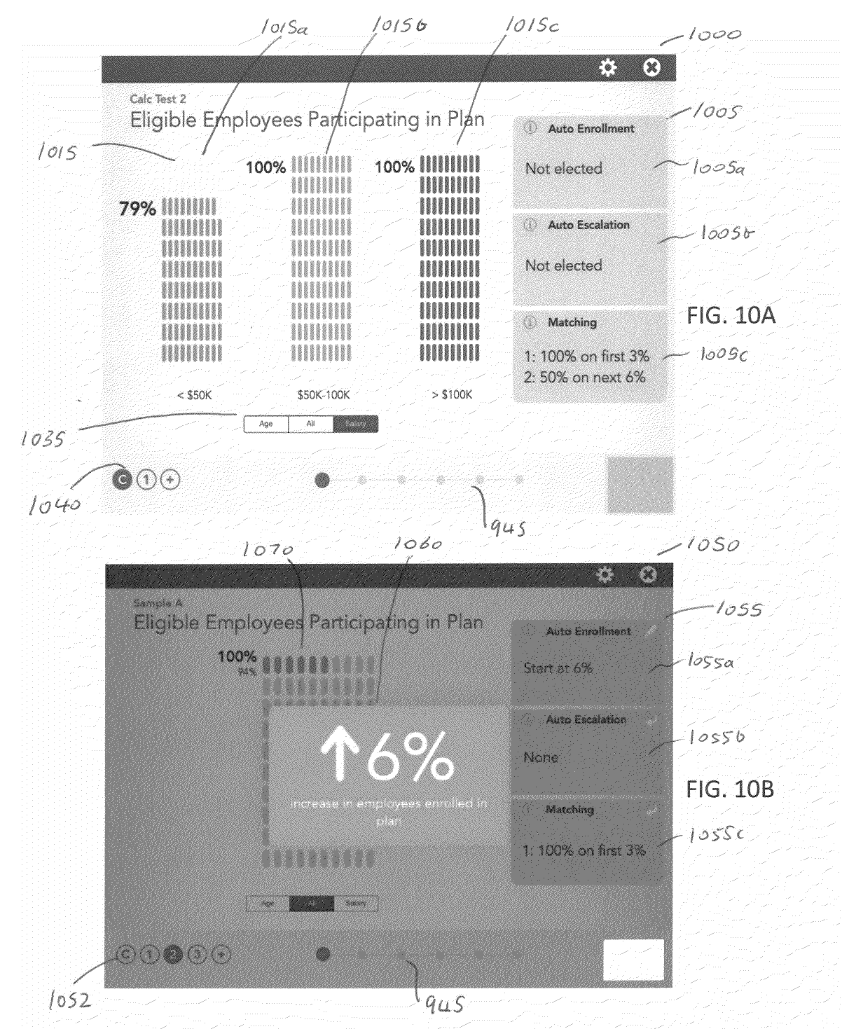

FIGS. 10A-10B show examples of how changes in selected metrics due to modeled plan changes can be summarized. In some embodiments, an analysis depicted in FIG. 9B can display eligible employee data based as a function of the employee's salary range. For example, referring to FIG. 10A, in some embodiments, a display screen 1000 can include data fields 1005, and statistics display 1015. In some embodiments, the data fields 1005 can comprise an auto enrollment tab 1005a, and/or an auto escalation tab 1005b, and/or a matching tab 1005c. In some embodiments, any of the tabs 1005a, 1005b, 1005c can comprise a parameter that can be selected or changed by the user to assess the impact on one or more retirement plan statistics. In some embodiments, the category toggle 1035 can be used to toggle an employee parameter based on an employee's salary. The current participation rate by salary is the percentage of eligible employees within specific salary ranges that are currently participating in the plan. In some embodiments, this is calculated by determining the participation rate for each of three salary ranges including under $50,000, $50,000 to $100,000, and $100,000. In some embodiments, current participation rate by salary can be calculated by summing the current participating employees in a salary range, then dividing the value by the total eligible employees in the salary range. In some embodiments, following a selection of one or more selectable retirement plan parameters, the plan analysis server system and method can calculate a statistics display 1015 based on one or more parameters or ranges shown in the data fields 1005. In some embodiments, the statistics display 1015 can comprise data bar 1015a representing data for employees earning less than $50,000, data bar 1015b representing data for employees earning between $50,000 and $100,000, and data bar 1015c representing data for employees earning more than $100,000. As previously discussed in relation to the teachings of FIG. 9A, various portions or steps of the process can be addressed within the display screen 900 as represented by the step or category indicator 945, and category of functionality can be displayed using the display icon 940.

In some embodiments, at least one simplified summary can be displayed and overlaid into a display for review by a user. For example, in some embodiments, the display can comprise an overlay within a graphical user interface of a display screen. In some embodiments, the overlap can appear prominent or lighted within a display screen that appears darker or more subdued. For example, referring to FIG. 10B, the display screen 1050 can include data fields 1055 comprising one or more selectable retirement plan parameters including single values or ranges that appear in a darkened or subdued portion of the display. Various portions or steps of the process can be addressed within the display screen 900 as represented by the step or category indicator 945, and category of functionality can be displayed using the display icon 1052. In some embodiments, display legend 1060 can be overlaid onto at least a portion of the display screen 1050. In some embodiments, display screen 1050 can include a calculation or summary data based on the data within at least one of the data fields 1055. In some embodiments, the data fields 1055 can comprise an auto enrollment tab 1055a, and/or an auto escalation tab 1055b, and/or a matching tab 1055c. In some embodiments, any of the tabs 1055a, 1055b, 1055c can comprise a parameter that can be selected or changed by the user to assess the impact on one or more retirement plan statistics.

The plan analysis server system and method defines an anticipated participation rate that is the percentage of all eligible employees that would be likely to participate in the plan (i.e., those who are currently deferring), based on the proposed plan attributes. To calculate the result, the plan analysis server system and method first identifies who will be included in auto enrollment based on flags provided with participant data. The plan analysis server system and method then looks at the deferral for the flagged participants and brings those individuals up to the new auto enrollment amount. When the anticipated participation rate is lower than the current participation rate, the plan analysis server system and method will display a warning instead of showing the proposed value, and when they are the same, the an output chart appears unchanged.

The anticipated participation rate by age is the percentage of all eligible employees within specific age groups that would be likely to participate in the plan (i.e., those who are currently deferring), based on the proposed plan attributes. Beginning with the results from the anticipated participation rate calculation, employees are split into age groups based on their birth date. The participation rate for each age group is then summed and divided by the total number of employees in each specific age group. When the anticipated participation rate is lower than the current participation rate, the plan analysis server system and method can display a warning instead of showing the proposed value, and when they are the same, the chart can appear unchanged. An anticipated participation rate by salary is defined as the percentage of all eligible employees within specific salary ranges that would be likely to participate in the plan (i.e., those who are currently deferring), based on the proposed plan attributes. Beginning with the results from the anticipated participation rate calculation, employees are split into groups based on their salary. The participation rate for each salary group is then summed and divided by the total number of employees in each specific salary group. When the anticipated participation rate is lower than the current participation rate, the plan analysis server system and method will display a warning instead of showing the proposed value, and when they are the same, the chart appears unchanged. The change in employee enrollment is the percentage change from the current participation rate to the anticipated participation rate. It can be calculated by dividing the difference of the two by the current rate.

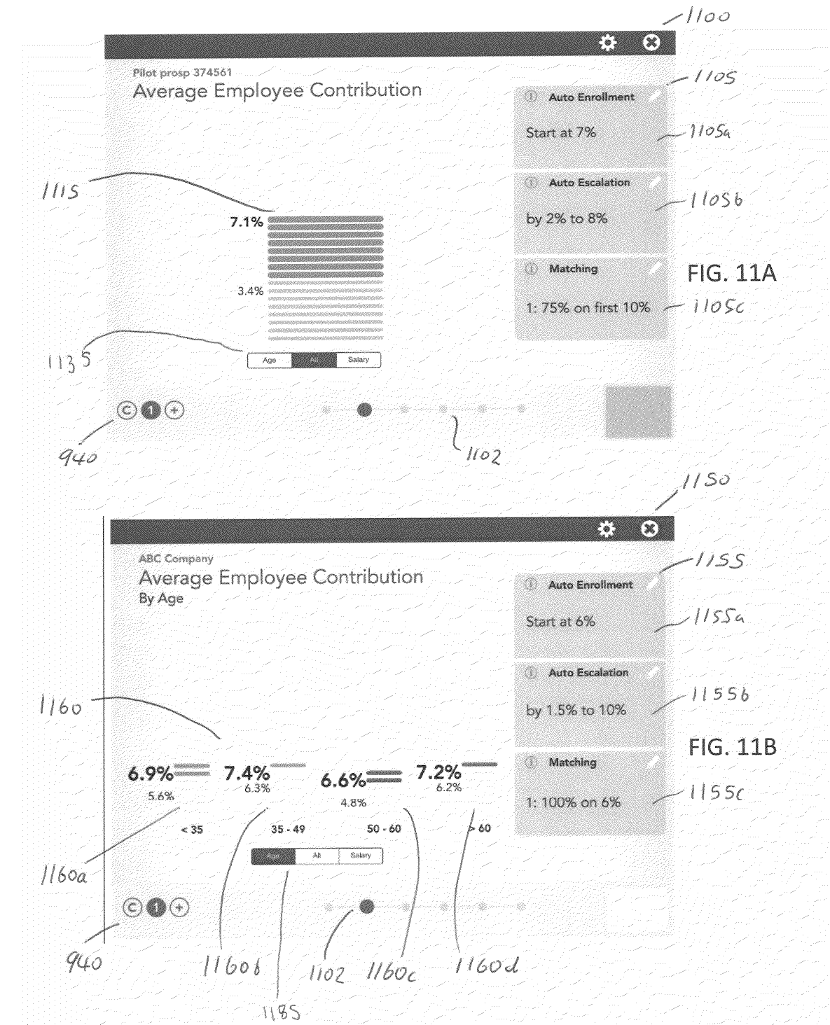

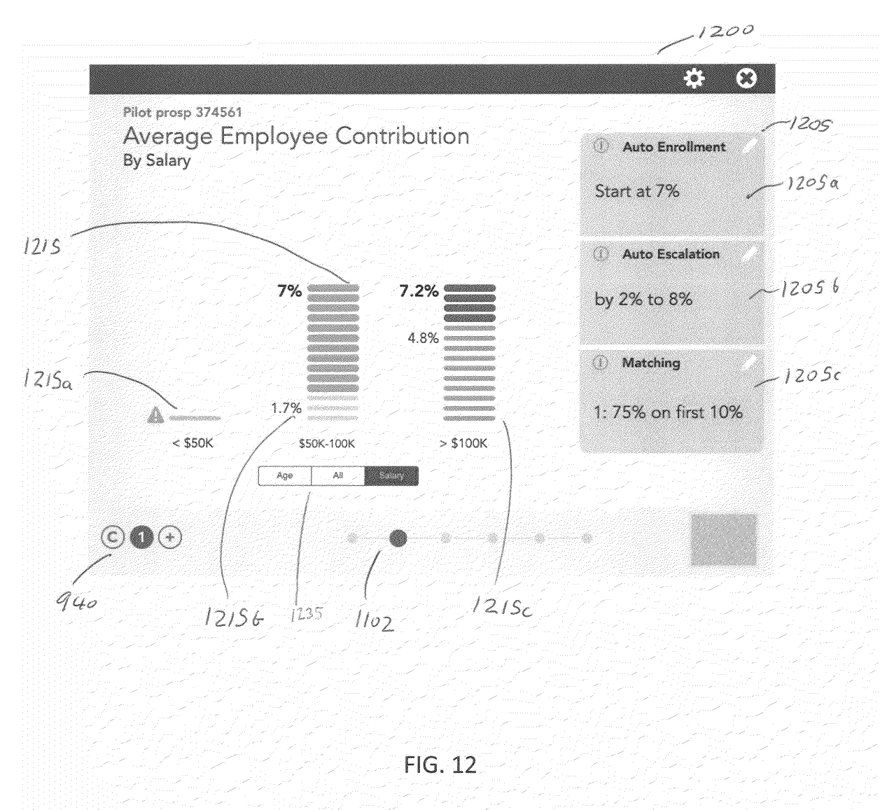

Referring to at least FIGS. 11A-11B and 12, the current average deferral percentage can be defined as the average percentage of salary contributed by all eligible employees who are participating in the plan (i.e., those who are deferring). In some embodiments, this is calculated by adding up the employee deferral percentage for all participating employees and dividing by the number of eligible employees. The current average deferral percentage by age is the average percentage of salary contributed by eligible employees (within specific age groups) who are currently participating in the plan. This is calculated by determining the average deferral for each of four age groups (e.g., under 35, 35 to 49, 50 to 59, and 60 and over). First, the plan analysis server system and method determines the age for each participant and places employees into age groups, sums the employee deferral percentage across participating employees in the age group, and divides by all eligible employees in the age group.

The current average deferral percentage by salary is the average percentage of salary contributed by eligible employees (within specific salary ranges) who are participating in the plan. This is calculated by determining the participation rate for each of three salary ranges (under $50,000; $50,000-$100,000; over $100,000) to calculate current average deferral percentage. The plan analysis server system and method first places employees into salary ranges, and then sums the employee deferral percentage for participating employees in a salary range. The TGG then divides the value by the total eligible employees in the salary range.

The anticipated average deferral percentage is the average percentage of salary contribution expected across all eligible employees projected to participate in the plan (i.e., those who are projected to be deferring), based on the proposed plan attributes. To calculate the result, in some embodiments, the plan analysis server system and method can first identify who will be included in auto enrollment based on flags provided with participant data. The plan analysis server system and method can then look at the deferral for the flagged participants and bring those individuals up to the new auto enrollment amount. The plan analysis server system and method can then add up the employee deferral percentage for all participating employees, and divide by the number of eligible employees.

In some embodiments, the employee auto-enroll flag and employee auto-enroll and escalate flag can be applied to participant data by the principal system prior to data being sent to the plan analysis server system and method application. In some embodiments, when the anticipated average deferral percentage is lower than the current average deferral percentage, the plan analysis server system and method can display a warning instead of showing the proposed value, and when they are the same, the chart can appear unchanged.

In some embodiments, beginning with the results from the anticipated average deferral percentage calculation, employees are split into age groups based on their birth date. The deferral percentage for each age group is then summed and divided by the total number of employees in each specific age group. In some embodiments of the invention, when the anticipated average deferral percentage is lower than the current average deferral percentage, the plan analysis server system and method can display a warning instead of showing the proposed value, and when they are the same, the chart appears unchanged.

The anticipated average deferral percentage by salary is the percentage of all eligible employees within specific salary ranges that represent a random selection of employees that will participate in the plan (based on the proposed plan attributes.) Beginning with the results from the anticipated average deferral percentage calculation, in some embodiments, employees are split into groups based on their salary. In some embodiments, the deferral percentage for each salary group is then summed and divided by the total number of employees in each specific salary group. In some embodiments of the invention, when the anticipated average deferral percentage is lower than the current average deferral percentage, the plan analysis server system and method displays a warning instead of showing the proposed value, and when they are the same, the chart appears unchanged. The change in average deferral is the percentage change from the current average deferral percentage to the anticipated average deferral percentage. It is calculated by dividing the difference of the two by the current percentage.

FIGS. 11A-11B show an example of how changes in selected metrics due to modeled plan changes can be summarized by showing the current plan's average employee contribution at 5.8% and the newly modeled percentage at 7.1%. More details based on selected metrics are provided as shown in FIG. 11B and in FIG. 12. All of the figures referenced herein can be displayed on one or more computer screens as desired. For example, referring to FIG. 11A, the display screen 1100 can comprise data fields 1105 comprising one or more selectable retirement plan parameters including single values or ranges. In some embodiments, a user can review and model data based on employee contribution parameters. In some embodiments, following a selection of one or more selectable retirement plan parameters, the plan analysis server system and method can calculate a statistics display 1115 based on one or more parameters or ranges shown in the data fields 1105. In some embodiments, the data fields 1105 can comprise an auto enrollment tab 1105a, and/or an auto escalation tab 1105b, and/or a matching tab 1105c. In some embodiments, any of the tabs 1105a, 1105b, 1105c can comprise a parameter that can be selected or changed by the user to assess the impact on one or more retirement plan statistics. In some further embodiments, the category toggle 1135 can be used to toggle an employee parameter for calculating or filtering calculated data shown in the statistics display 1115 including, but not limited to, employee age and employee salary. In some embodiments, the category toggle 1135 can be used to select all employees without any filtering by age and/or salary, or other filter.

In some embodiments, an analysis depicted in FIG. 11B can display employee contribution data based as a function of the employees age. For example, referring to FIG. 11B, in some embodiments, a display screen 1150 can include data fields 1155, and statistics display 1160. In some embodiments, the data fields 1155 can comprise an auto enrollment tab 1155a, and/or an auto escalation tab 1155b, and/or a matching tab 1155c. In some embodiments, any of the tabs 1155a, 1155b, 1155c can comprise a parameter that can be selected or changed by the user to assess the impact on one or more retirement plan statistics. In some embodiments, the category toggle 1185 can be used to toggle an employee parameter based on an employee's age. In some embodiments, following a selection of one or more selectable retirement plan parameters, the plan analysis server system and method can calculate a statistics display 1160 based on one or more parameters or ranges shown in the data fields 1155. In some embodiments, the statistics display 1160 can comprise data bar 1160a representing data for employees less than 35 years old, and/or data bar 1160b representing data for employees between 35 and 49 years old, data bar 1160c representing data for employees between 50 and 60 years old, and data bar 1160d representing data for employees greater than 60 years old.

In some embodiments, the plan analysis server system and method can display employee contribution data based on a function of the employee's salary range. For example, referring to FIG. 12, in some embodiments, a display screen 1200 can include data fields 1205, and statistics display 1215, and a category toggle 1235 that can be used to toggle an employee parameter based on an employee's salary. In some embodiments, following a selection of one or more selectable retirement plan parameters, the plan analysis server system and method can calculate a statistics display 1215 based on one or more parameters or ranges shown in the data fields 1205. In some embodiments, the data fields 1205 can comprise an auto enrollment tab 1205a, and/or an auto escalation tab 1205b, and/or a matching tab 1205c. In some embodiments, any of the tabs 1205a, 1205b, 1205c can comprise a parameter that can be selected or changed by the user to assess the impact on one or more retirement plan statistics. In some embodiments, the statistics display 1215 can comprise data bar 1215a representing data for employees earning less than $50,000, data bar 1215b representing data for employees earning between $50,000 and $100,000, and data bar 1215c representing data for employees earning more than $100,000. As previously discussed, various portions or steps of the process can be addressed within the display screen 900 as represented by the step or category indicator (shown as 1102 in the example embodiment of FIG. 12).

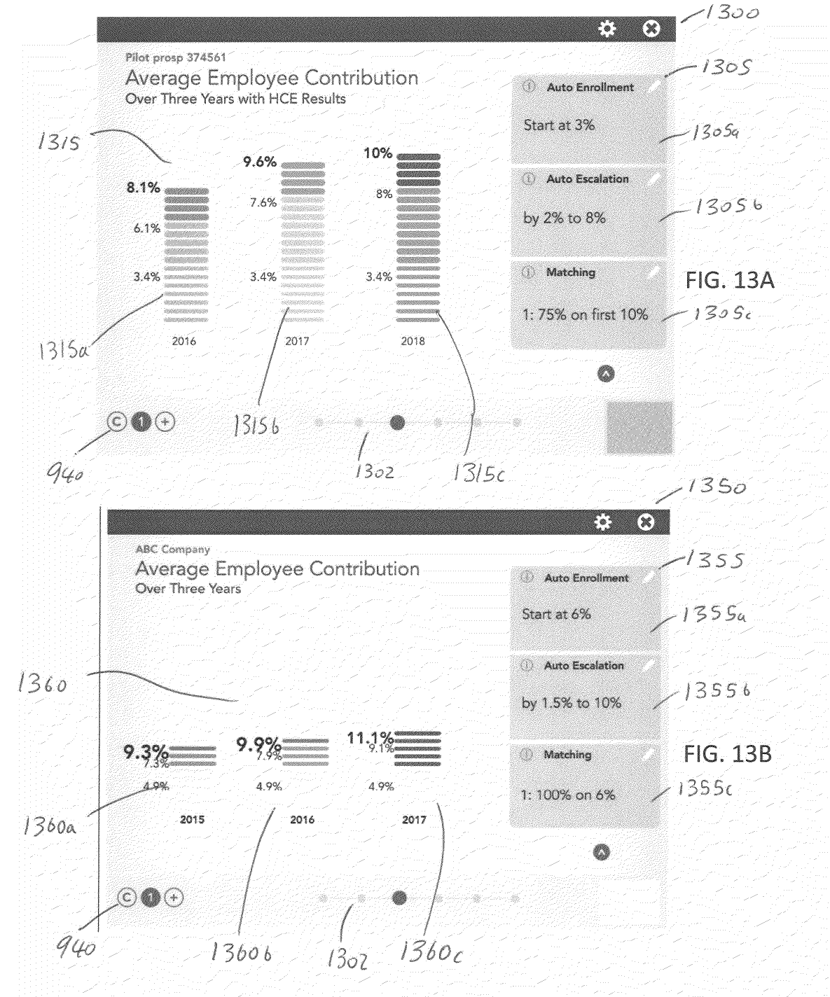

In reference to at least FIGS. 13A-13B, the current average deferral percentage in 1 year is a projected average percentage of salary contributed by all eligible employees who are participating in the plan (i.e., those who are deferring). To calculate the result, in some embodiments, the plan analysis server system and method can first identifies who will be included in auto escalation based on flags provided with participant data. In some embodiments, the plan analysis server system and method can then increase each employee deferral percentage by the auto-escalation percentage (not to exceed the auto-escalation limit), for each employee pre-selected as using auto-escalation. The employee deferral percentage can then be summed for all eligible employees and then divided by the eligible employee count. In some embodiments, the employee auto-escalation flag, employee auto-enroll, and escalate flag can be applied to participant data by the principal system prior to data being sent to the plan analysis server system and method application.

The current average deferral percentage in 2 years is a projected average percentage of salary contributed by all eligible employees who are currently participating in the plan (i.e., those who are currently deferring). To calculate the result, in some embodiments, the plan analysis server system and method can first identify who will be included in auto escalation based on flags provided with participant data. The plan analysis server system and method can then increase each employee deferral percentage by the auto-escalation percentage (not to exceed the auto-escalation limit), for each employee pre-selected as using auto-escalation. The employee deferral percentage can then summed for all eligible employees and then divided by the eligible employee count. The employee auto-escalation flag and employee auto-enroll and escalate flag can be applied to participant data prior to data being sent to the plan analysis server system and method application.

The current average deferral percentage in 3 years is a projected average percentage of salary contributed by all eligible employees who are currently participating in the plan (i.e., those who are currently deferring). To calculate the result, in some embodiments, the plan analysis server system and method first identifies who will be included in auto escalation based on flags provided with participant data. The plan analysis server system and method then increases each employee deferral percentage by the auto-escalation percentage (not to exceed the auto-escalation limit), for each employee pre-selected as using auto-escalation. The employee deferral percentage can then summed for all eligible employees, and then divided by the eligible employee count. In some embodiments, the employee auto-escalation flag, employee auto-enroll, and escalate flag can then be applied to participant data by the plan analysis server system and method prior to data being sent to the plan analysis server system and method application.

The current average deferral percentage hce cap is the maximum average deferral percentage permitted for all highly compensated employees in the plan. This is calculated by adding 2% to the current average deferral percentage for each year. It can be made to appear by tapping an hce cap icon, and only applies to the current average deferral percentage if the plan attributes have not yet been revealed.

The anticipated average deferral percentage in 1 year is a projected average percentage of salary contributed by all eligible employees who are participating in the plan (i.e., those who are deferring), based on the attributes of the proposed scenario. To calculate the result, the plan analysis server system and method first identifies who will be included in auto escalation based on flags provided with participant data. The plan analysis server system and method application then increases each employee deferral percentage by the auto-escalation percentage (not to exceed the auto-escalation limit), for each employee pre-selected as using auto-escalation. The employee deferral percentage is then summed for all eligible employees and then divided by the eligible employee count. The employee auto-escalation flag and employee auto-enroll and escalate flag can then be applied to participant data by the principal system prior to data being sent to the plan analysis server system and method. In some embodiments, if the selected scenario incorporates auto enrollment, then the starting point for the projected deferrals is the calculated employee deferral percentage from the auto-enrollment calculations. When the anticipated average deferral percentage in 1 year is lower than the current average deferral percentage in 1 year, the plan analysis server system and method can display a warning instead of showing the proposed value, and when they are the same, the chart appears unchanged.

The anticipated average deferral percentage in 2 years is a projected average percentage of salary contributed by all eligible employees who are currently participating in the plan (i.e., those who are currently deferring), based on the attributes of the proposed scenario. To calculate the result, in some embodiments, the plan analysis server system and method first identifies who will be included in auto escalation based on flags provided with participant data. In some embodiments, the plan analysis server system and method application can hen increase each employee deferral percentage by the auto-escalation percentage (not to exceed the auto-escalation limit), for each employee pre-selected as using auto-escalation. The employee deferral percentage can then summed for all eligible employees, and then divided by the eligible employee count. In some embodiments, the employee auto-escalation flag and employee auto-enroll and escalate flag can be applied to participant data by the plan analysis server system and method prior to data being sent to the plan analysis server system and method application. If the selected scenario incorporates auto enrollment, then the starting point for the projected deferrals is the calculated employee deferral percentage from the auto-enrollment calculations. When the anticipated average deferral percentage in 2 years is lower than the current average deferral percentage in 2 years, the plan analysis server system and method displays a warning instead of showing the proposed value, and when they are the same, the chart appears unchanged.

The anticipated average deferral percentage in 3 years is a projected average percentage of salary contributed by all eligible employees who are currently participating in the plan (i.e., those who are currently deferring), based on the attributes of the proposed scenario. To calculate the result, in some embodiments, the plan analysis server system and method can first identify who will be included in auto escalation based on flags provided with participant data. The plan analysis server system and method application can then increases each employee deferral percentage by the auto-escalation percentage (not to exceed the auto-escalation limit), for each employee pre-selected as using auto-escalation. In some embodiments, the employee deferral percentage can then summed for all eligible employees, and then divided by the eligible employee count. In some embodiments, the employee auto-escalation flag and employee auto-enroll and escalate flag can be applied to participant data by the principal system prior to data being sent to the plan analysis server system and method. If the selected scenario incorporates auto enrollment, the starting point for the projected deferrals is the calculated employee deferral percentage from the auto-enrollment calculations. When the anticipated average deferral percentage in 3 years is lower than the current average deferral percentage in 3 years, the plan analysis server system and method can display a warning instead of showing the proposed value, and when they are the same, the chart appears unchanged. In some embodiments, the anticipated average deferral percentage hce cap is the maximum average deferral percentage permitted for all highly compensated employees in the plan. In some embodiments, this is calculated by adding 2% to the anticipated average deferral percentage for each year. The change in average deferral in 3 years is the percentage change from the current average deferral percentage in 3 years to the anticipated average deferral percentage in 3 years. It is calculated by dividing the difference of the two by the current percentage. Referring to FIG. 13A, showing data that includes analysis for highly compensated employees, in some embodiments, a display screen 1300 can include data fields 1305, and statistics display 1315. In some embodiments, following a selection of one or more selectable retirement plan parameters, the plan analysis server system and method can calculate a statistics display 1315 based on one or more parameters or ranges shown in the data fields 1305. In some embodiments, the data fields 1305 can comprise an auto enrollment tab 1305a, and/or an auto escalation tab 1305b, and/or a matching tab 1305c. In some embodiments, any of the tabs 1305a, 1305b, 1305c can comprise a parameter that can be selected or changed by the user to assess the impact on one or more retirement plan statistics. In some embodiments, the statistics display 1315 can comprise data bar 1315a representing data for employees earning in a first year (represented as 2016), data bar 1315b representing data for employees earning in a second year (represented as 2017), and data bar 1315c representing data for employees earning in a third year (represented as 2018). Further, for example, referring to FIG. 13B, including an analysis over three years for all employees, in some embodiments, a display screen 1350 can include data fields 1355, and statistics display 1360. In some embodiments, following a selection of one or more selectable retirement plan parameters, the plan analysis server system and method can calculate a statistics display 1360 based on one or more parameters or ranges shown in the data fields 1355. In some embodiments, the data fields 1355 can comprise an auto enrollment tab 1355a, and/or an auto escalation tab 1355b, and/or a matching tab 1355c. In some embodiments, any of the tabs 1355a, 1355b, 1355c can comprise a parameter that can be selected or changed by the user to assess the impact on one or more retirement plan statistics. In some embodiments, the statistics display 1360 can comprise data bar 1360a representing data for employees earning in a first year (year 2015), data bar 1360b representing data for employees earning in a second year (year 2016), and data bar 1360c representing data for employees earning in a third year (year 2017).

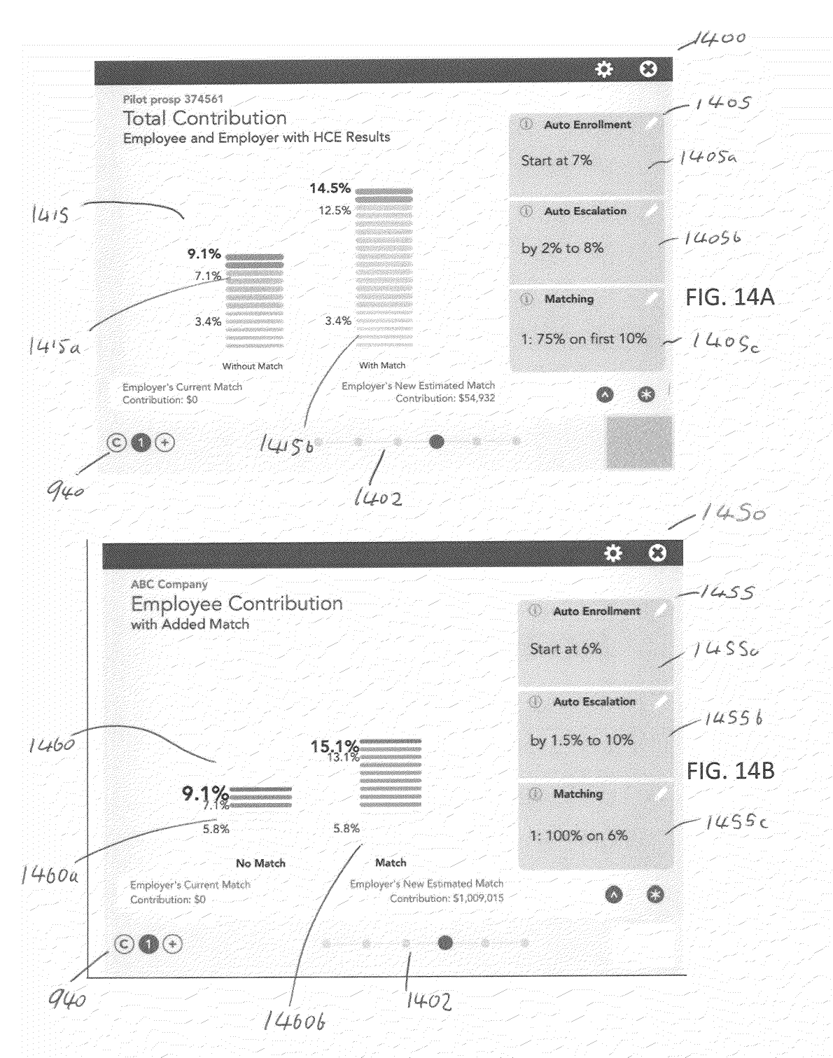

In some embodiments, differences in performance between different models or scenarios including or not including matching can be compared as shown in FIGS. 14A-14B. Tapping or mouse clicking on the computer or tablet screen can cause new information to be displayed including percentage increase in selected metrics or other desired information. The current average deferral percentage without match is the average percentage of salary contributed by all eligible employees who are participating in the plan (i.e., those who are deferring). In some embodiments, this can be calculated by adding up the employee deferral percentage for all participating employees, and dividing by the number of eligible employees.

The anticipated average deferral percentage without match is the average percentage of salary contribution expected across all eligible employees projected to participate in the plan (i.e., those who are projected to be deferring), based on the proposed plan attributes, without considering any matching contributions by the employer. In some embodiments, to calculate the result, the plan analysis server system and method can first identify who will be included in auto enrollment based on flags provided with participant data. In some embodiments, the plan analysis server system and method can then look at the deferral for the flagged participants and brings those individuals up to the new auto enrollment amount. In some embodiments, the employee deferral percentage can then added for all participating employees and divided by the number of eligible employees. In some embodiments, when the anticipated average deferral percentage without match is lower than the current average deferral percentage without match, the plan analysis server system and method can display a warning instead of showing the proposed value, and when they are the same, the chart appears unchanged.

The anticipated average deferral percentage hce cap without match is the maximum average deferral percentage permitted for all highly compensated employees in the plan when the employer does not offer any contribution matching. This is calculated by adding 2% to the anticipated average deferral percentage without match. This appears by tapping an hce cap icon and only applies to the current average deferral percentage if the plan attributes have not yet been revealed.

The current average deferral percentage with match is the average percentage of salary contributed by all eligible employees who are participating in the plan (i.e., those who are deferring) after considering employer matching. This is calculated by adding the average deferral percentage and the average matching percentage, both displayed on the plan metrics view.

The anticipated average deferral percentage with match is the average percentage of salary contribution expected across all eligible employees projected to participate in the plan (i.e., those who are projected to be deferring) (based on the proposed plan attributes) including the employer match. In some embodiments, first, the plan analysis server system and method calculates the matching percentage for each participating employee by multiplying the tier 1 match percentage by the smaller of either the anticipated employee deferral percentage or the tier 1 limit. In some embodiments, if there is a tier 2 match, the plan analysis server system and method calculates the matching percentage for each participating employee by multiplying the tier 2 match percentage by the smaller of either the remaining anticipated employee deferral percentage or the tier 2 limit, and adds the value to the tier 1 matching percentage. If there is a tier 3 match, the plan analysis server system and method calculates the matching percentage for each participating employee by multiplying the tier 3 match percentage by the smaller of either the remaining anticipated employee deferral percentage or the tier 3 limit, and adds the value to the tier 2 matching percentage. In some embodiments, the plan analysis server system and method can then calculate the average by summing the matching percentage the employer would pay to all employees participating in the plan, and dividing that value by the total number of participating employees (based on the proposed scenario). In some embodiments, the matching average is then added to the anticipated average deferral percentage for the scenario. When the anticipated average deferral percentage with match is lower than the current average deferral percentage with match, the plan analysis server system and method displays a warning instead of showing the proposed value, and when they are the same, the chart appears unchanged. The anticipated average deferral percentage hce cap with match is the maximum average deferral percentage permitted for all highly compensated employees in the plan, including for the employer's matching. In some embodiments, this can be calculated by adding 2% to the anticipated average deferral percentage with match.

In some embodiments, the employer's current match contribution is an estimate of the maximum dollar amount that the employer would contribute to the plan this year based on the current employee salaries and current matching. In some embodiments, first, the plan analysis server system and method can calculate the maximum matching percentage by multiplying the tier 1 match percentage by the tier 1 limit. If there is a tier 2 match, the app multiplies the tier 2 match percentage by the tier 2 limit, and adds the value to the tier 1 maximum matching percentage. If there is a tier 3 match, the app multiplies the tier 3 match percentage by the tier 3 limit, and adds the value to the tier 2 maximum matching percentage. In some embodiments, the plan analysis server system and method can then sum of all employee salaries, regardless of participation, to identify the total salary cost. In some embodiments, to calculate the employer's current match contribution, the plan analysis server system and method multiplies the total salary cost by the maximum matching percentage (by 85%.)

The employer's new estimated match contribution is an estimate of the maximum dollar amount the employer would contribute to the plan this year, based on the current employee salaries and current matching. In some embodiments, first, the plan analysis server system and method calculates the maximum matching percentage by multiplying the tier 1 match percentage by the tier 1 limit. If there is a tier 2 match, the plan analysis server system and method multiplies the tier 2 match percentage by the tier 2 limit, and adds the value to the tier 1 maximum matching percentage. If there is a tier 3 match, the plan analysis server system and method multiplies the tier 3 match percentage by the tier 3 limit, and adds the value to the tier 2 maximum matching percentage. In some embodiments, the plan analysis server system and method can then sum all employee salaries, regardless of participation, to identify the total salary cost. To calculate the employer's new estimated match contribution, in some embodiments, the plan analysis server system and method multiplies the total salary cost by the maximum matching percentage by 85%. The change in average employee savings with match contribution is the percentage change from the current average deferral percentage with match to the anticipated average deferral percentage with match. It is calculated by subtracting the current average deferral percentage with match from the anticipated average deferral percentage with match, then dividing the result by the current average deferral percentage with match.

Referring to FIG. 14A, in some embodiments, the plan analysis server system and method can display total employee contribution data based on a function of an employee receiving or not receiving an employer match. Referring to FIG. 14A, in some embodiments, a display screen 1400 can include data fields 1405, and statistics display 1415 including highly compensated employee contribution data. In some embodiments, following a selection of one or more selectable retirement plan parameters, the plan analysis server system and method can calculate a statistics display 1415 based on one or more parameters or ranges shown in the data fields 1405. In some embodiments, the data fields 1405 can comprise an auto enrollment tab 1405a, and/or an auto escalation tab 1405b, and/or a matching tab 1405c. In some embodiments, any of the tabs 1405a, 1405b, 1405c can comprise a parameter that can be selected or changed by the user to assess the impact on one or more retirement plan statistics. In some embodiments, the data bar 1415b represents data for employees not receiving a match, and data bar 1415b represents data for employees receiving a match. As previously discussed, various portions or steps of the process can be addressed within the display screen 1400 as represented by the step or category indicator (shown as 1402).

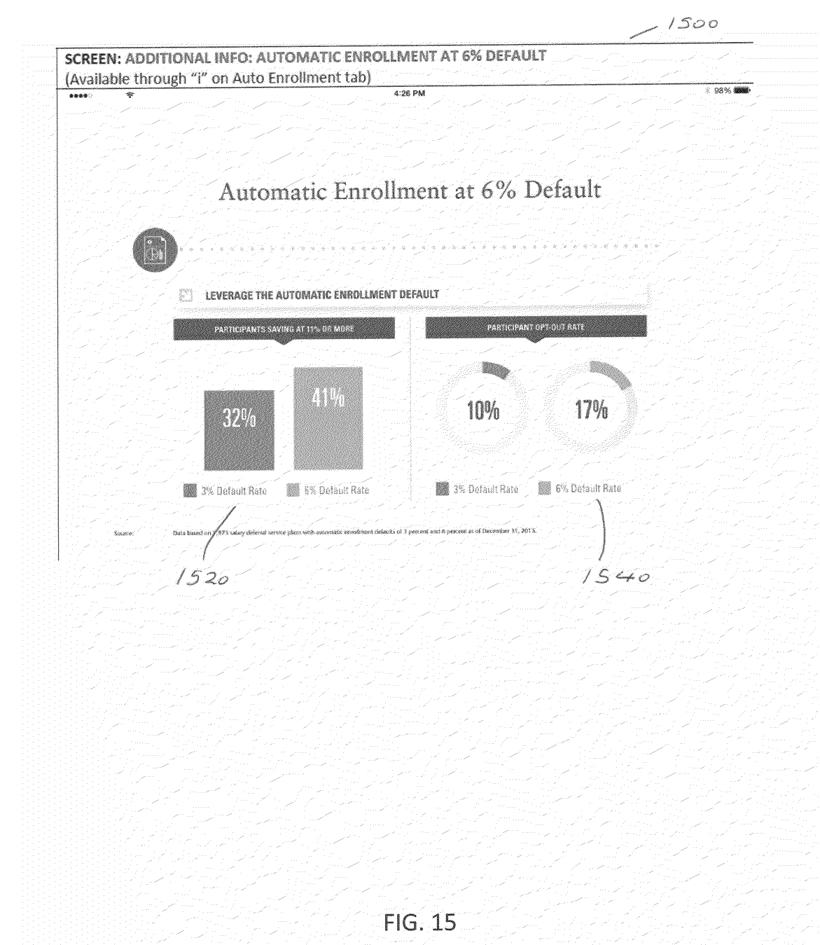

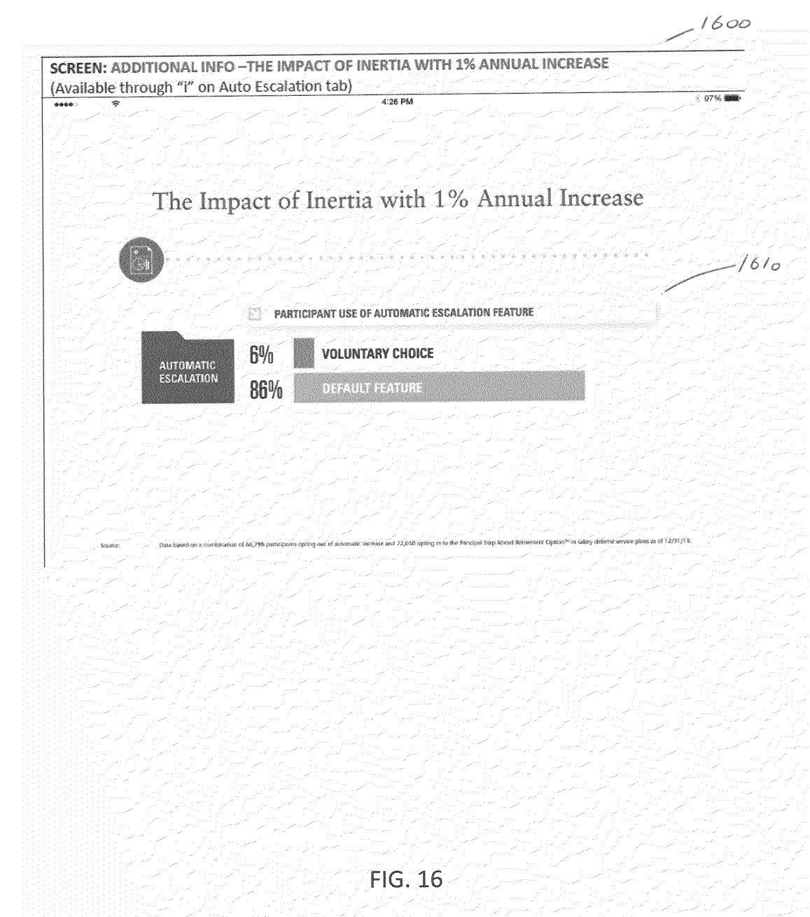

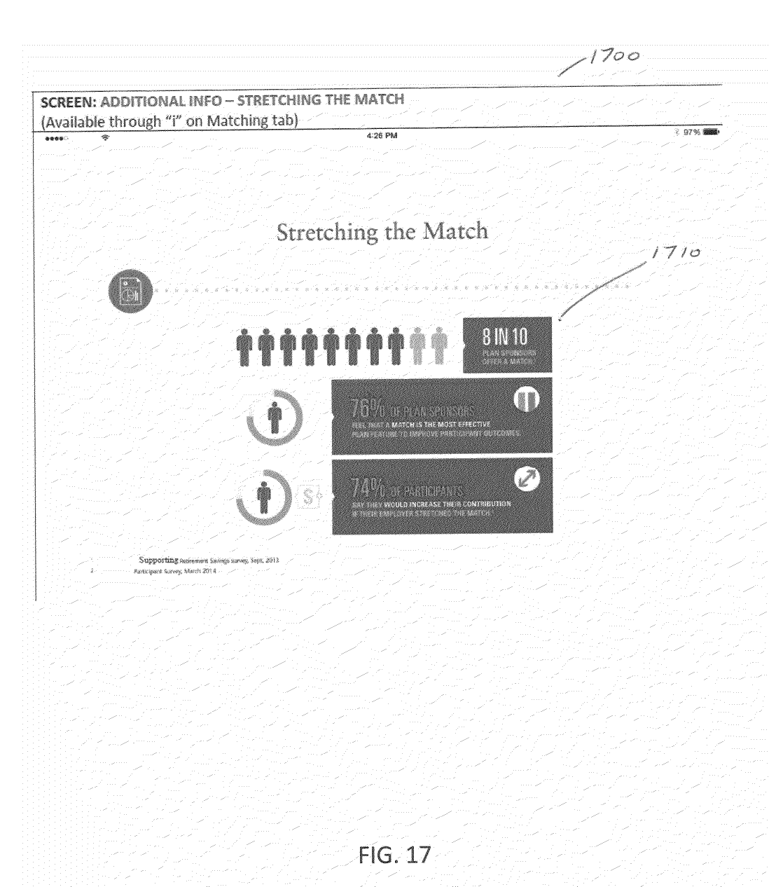

In some embodiments, tapping or mouse clicking on the “i” button on any of the Auto Enrollment tabs described above and shown in FIGS. 11A-11B, 12, 13A-13B, and 14A-14B can enable a user to generate the comparison information shown in FIG. 15. In some embodiments, the display screen 1500 can include a data field 1520 illustrating a display of data comparing employee savings at a default enrollment rate. The data field 1540 can include data showing the employee opt-out rate as a function of default enrollment. Further, in some embodiments, tapping or mouse clicking on the “i” button on any of the Auto Escalation tabs described above and shown in FIGS. 11A-11B, 12, 13A-13B, and 14A-14B can enable a user to generate the comparison information shown in FIG. 16. For example, display screen 1600 can include a display of a data field 1610 comprising participant use of an automatic escalation feature. Further, in some embodiments, tapping or mouse clicking on the “i” button on any of the Auto Escalation tabs described above and shown in FIGS. 11A-11B, 12, 13A-13B, and 14A-14B can enable a user to generate the comparison information shown in FIG. 17. In some embodiments, display screen 1700 can include data field 1710 comprising an illustration of an employee and plan statistical responses based on matching of employee contributions within a plan.

The “employees on track” is the percentage of employees whose retirement plan accounts are sufficiently funded to support their retirement (defaulted to 85% replacement level per principal corporate common assumptions). In some embodiments, the plan analysis server system and method first adds together the future values of the employee account balance, the employee contributions, total employer contributions for each employee, and the auto-escalated employee contributions. In some embodiments, the future value for the employee can then be compared against a sum of the target dc replacement and social security dc replacement to determine if the employee is on track. From there, the plan analysis server system and method can then sum the number of employees on track, and then divide that value by the total number of eligible employees. In some embodiments, to determine years until retirement, the plan analysis server system and method can subtract the participant's age from the assumed retirement age of 65. In some embodiments, the employee account balance can be increased by the annual rate of return for the number of years until retirement. In some embodiments, the plan analysis server system and method can calculate a future value of employee balances and contributions instead of calculating values year-over-year. In some embodiments, the annual rate of return and annual salary increase plan assumptions can be factored into the calculation.

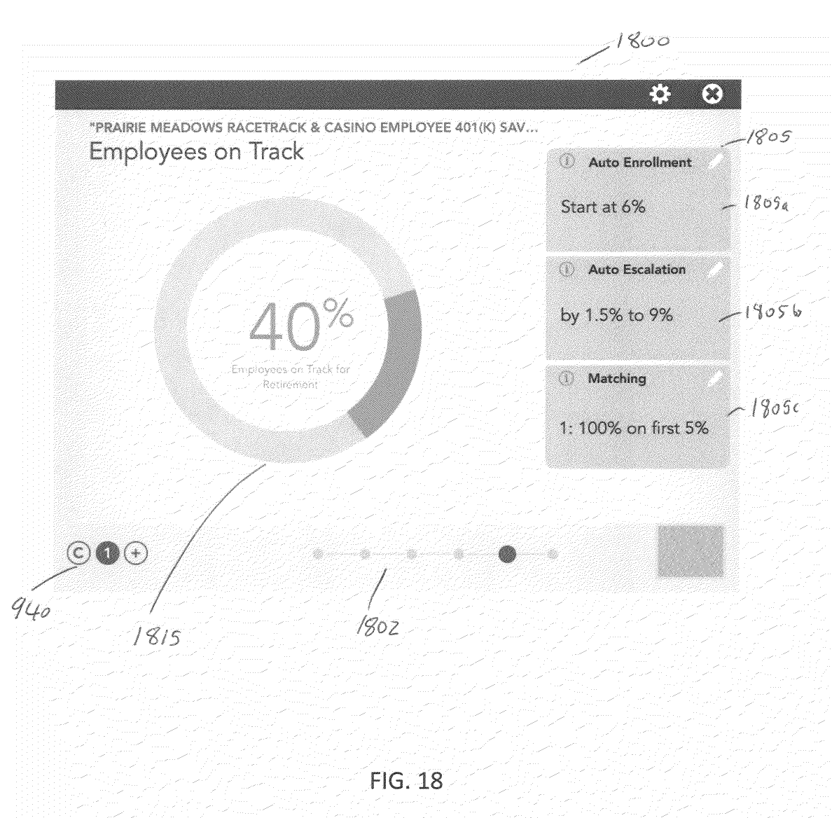

In reference to at least FIG. 18, the anticipated employees on track is the percentage of employees whose retirement plan accounts are sufficiently funded to support their retirement (defaulted to 85% replacement level per principal corporate common assumptions), based on the proposed plan attributes. In some embodiments, the plan analysis server system and method first adds together the future values of the employee account balance, the anticipated employee contributions, and the total anticipated employer contributions for each employee. In some embodiments, the future value for the employee can then be compared against a sum of the target dc replacement and social security dc replacement to determine if the employee is on track. From there, the plan analysis server system and method sums the number of employees on track, and then divides that value by the total number of eligible employees. To determine years until retirement, the plan analysis server system and method can then subtract the participant's age from the assumed retirement age of 65. The employee account balance can then be increased by the annual rate of return for the number of years until retirement. In some embodiments, the plan analysis server system and method can calculate a future value of employee balances and contributions instead of calculating values year-over-year. The annual rate of return and annual salary increase plan assumptions are factored into the calculation. Further, the calculation factors in auto enrollment through the anticipated employee deferral percentage and matching through the employer's maximum matching percentage. In some embodiments, when the “Anticipated Employees On Track” is lower than the “Employees On Track”, the plan analysis server system and method can display a warning instead of showing the proposed value, and when they are the same, the chart can appear unchanged. The change in employees on track is the percentage change from the employees on track to the anticipated employees on track. It is calculated by subtracting the employees on track from the anticipated employees on track, then dividing the result by the employees on track.

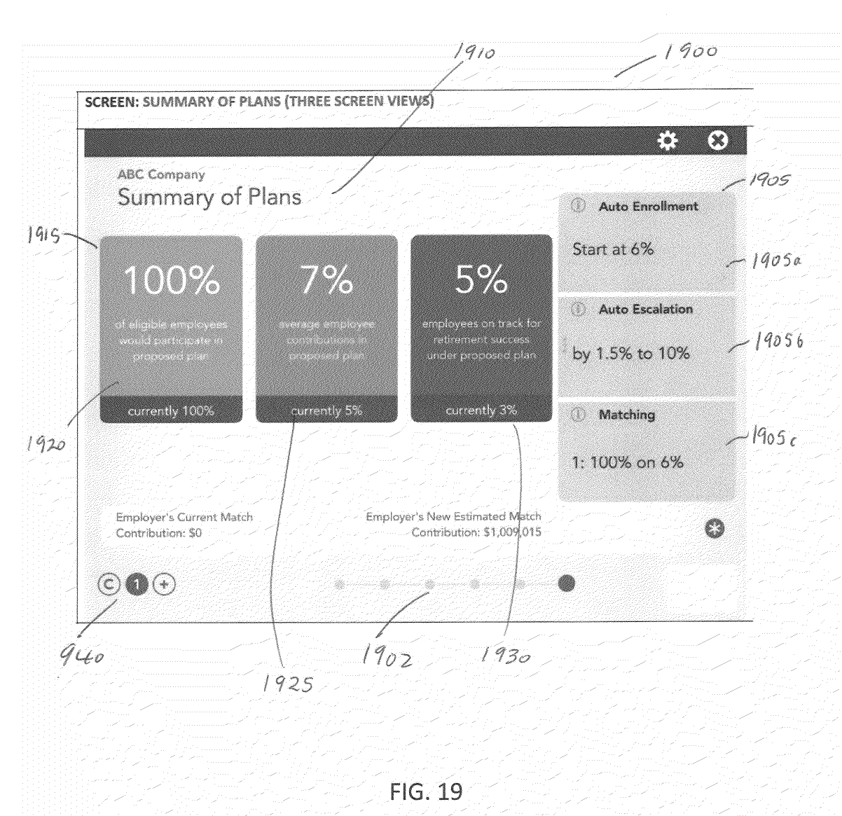

Some embodiments of the plan analysis server system and method can provide the summary screen shown in FIGS. 18 and 19, which can summarize the selected metrics and the modeled results of employees on track for retirement. Some embodiments enable the user to select desired metrics, generate models and easily refine those models and then set up a presentation focusing on information most helpful to the employer. Once the user is in a meeting with the employer's representatives, some embodiments enable the presentation to be readily retrieved and displayed on a tablet or other computing device. For example, referring to FIG. 18 and display screen 1800, in some embodiments, data fields 1805 can comprise an auto enrollment tab 1805a, and/or an auto escalation tab 1805b, and/or a matching tab 1805c. In some embodiments, any of the tabs 1805a, 1805b, 1805c can comprise a parameter that can be selected or changed by the user to assess the impact on one or more retirement plan statistics. In some embodiments, following a selection of one or more selectable retirement plan parameters, the plan analysis server system and method can calculate a statistics display 1815 based on one or more parameters or ranges shown in the data fields 1805. Various portions or steps of the process can be addressed within the display screen 1800 as represented by the step or category indicator (shown as 1802).

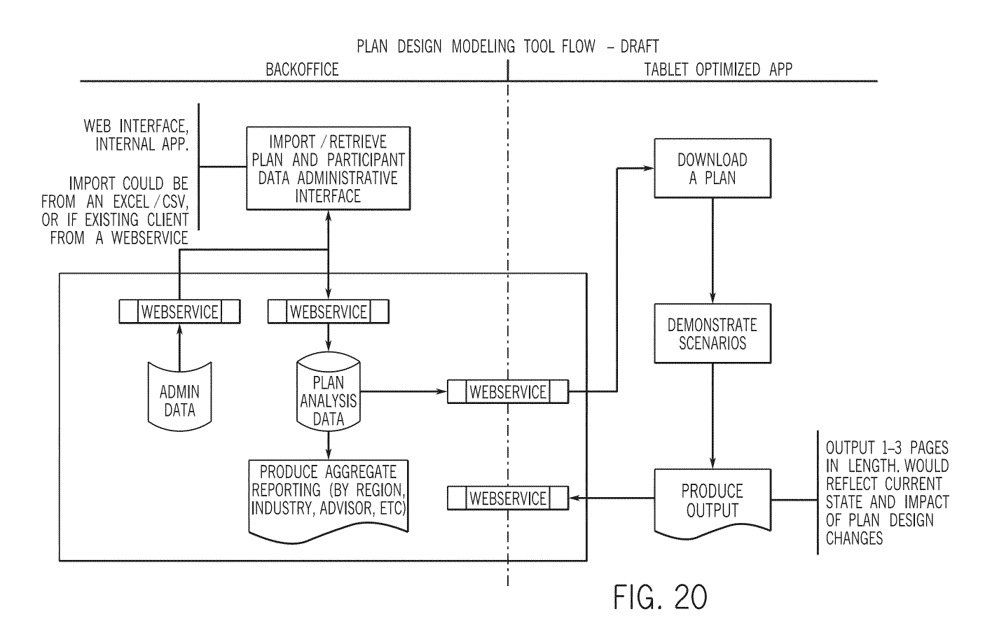

In some embodiments, the plan analysis server system and method can prepare a summary of plans. For example, referring to FIG. 20, showing a summary that includes analysis across all employees, in some embodiments, a display screen 1900 can include data fields 1905, and summary display 1910 comprising statistics for plans for all employees, with the step or category indicator shown as 1902. In some embodiments, following a selection of one or more selectable retirement plan parameters, the plan analysis server system and method can calculate a statistics display 1915 based on one or more parameters or ranges shown in the data fields 1905. In some embodiments, the data fields 1905 can comprise an auto enrollment tab 1905a, and/or an auto escalation tab 1905b, and/or a matching tab 1905c. In some embodiments, any of the tabs 1905a, 1905b, 1905c can comprise a parameter that can be selected or changed by the user to assess the impact on one or more retirement plan statistics contained in the summary. In some embodiments, the statistics display 1915 can comprise data box 1920 representing data for 100% of employees participating in a proposed plan, a data bar 1925 representing data for average employee contribution amounts, and data bar 1930 representing data for employees that are on track for retirement.

FIG. 20 shows an example of a process and data flow 2000 in accordance with some embodiments of the invention. In some embodiments, a back office server infrastructure 2010 can store and retrieve data under the control of at least one processor. A tablet or other computing device can download and upload data to and from non-transitory computer readable media as desired. One or more web servers can support a wide variety of interfaces for such data exchange. The back office server infrastructure 2010 can include data analytics and report generation capabilities in some embodiments. In some embodiments, a data interface to the back office server infrastructure 2010 can comprise a web interface application 2015. In some embodiments, using a process 2020, the back office server infrastructure 2010 can import or retrieve plan and participant data. Some embodiments include a webservice 2025 coupled to administrative data 2035. Further, in some embodiments, webservice 2030 can output plan analysis data 2040 and report through a process 2050. In some embodiments, the Tablet optimized flow 2060 can comprise coupling from the back office server infrastructure 2010 with webservice 2065 (flowing the aforementioned report through process 2050. In some embodiments, the tablet optimized flow 2060 can comprise a process 2070 for downloading a plan, process 2075 producing one or more scenarios. In some embodiments, data output process 2080 can process output data 2085, and output data to the back office server infrastructure 2010 through webservice 2090.

In some embodiments of the invention, the plan analysis server system and method can utilize one or more calculation variables when calculating and displaying retirement plan data. Some embodiments utilize plan variables and other embodiments utilize employee variable. For example, in some embodiments, the plan analysis server system and method can utilize plan variables comprising a “Target DC Replacement” variable, defined as the percentage of an employee's income at retirement that is expected to be funded by retirement savings. The percentage is assumed to be 45%, and in some embodiments, the plan analysis server system and method defaults to this value. Users can change the value in the application.

In some embodiments, the plan analysis server system and method can utilize a plan variable comprising a “Social Security DC Replacement” variable defined as the percentage of an employee's income at retirement that we expect to be funded by Social Security. In some embodiments, the plan analysis server system and method application assumes 40%, and defaults to this value. Users can change the default value in the application.

In some embodiments, the plan analysis server system and method can utilize a plan variable comprising a “Annual Salary Increase” variable defined as the assumed annual percentage increase expected for the employees' salaries. In some embodiments, the plan analysis server system and method application assumes 3.5%, and defaults to this value. However, users can change the default value in the application.

In some embodiments, the plan analysis server system and method can utilize a plan variable comprising a “Annual Rate of Return” variable defined as the assumed annual rate of return anticipated on the investment accounts. The plan analysis server system and method application assumes 7%, and defaults to this value. Users can change the default value in the application.

In some embodiments, the plan analysis server system and method can utilize a plan variable comprising a “Annual Inflation Rate” variable defined as the assumed annual inflation rate. The plan analysis server system and method application assumes 2.5%, defaults to this value. Users can change the default value in the application.

In some embodiments, the plan analysis server system and method can utilize a plan variable comprising a “Retirement Age” variable defined as the assumed age employees in the plan will retire. The plan analysis server system and method application assumes the retirement age is 65, and defaults to this value. Users can change the default value in the application.

In some embodiments, the plan analysis server system and method can utilize a plan variable comprising a “Annual Withdrawal Rate” variable defined as the assumed rate by which funds will be withdrawn from the account upon retirement. The plan analysis server system and method application assumes 4.5% in the first year, and defaults to this value. Users can change the default value in the application.

In some embodiments, the plan analysis server system and method can utilize a plan variable comprising a “Plan Employer Match” variable defined as a “Yes” or “No” selection on plan analysis server system and method upload page to indicate if a plan offers an employer match. The selection is made by plan analysis server system and method app user as described earlier with respect to employer match selection updated using the toggle 132.

In some embodiments, the plan analysis server system and method can utilize a plan variable comprising a “Plan Employer Match Tiers” variable defined as one or more beginning tiered match percentage(s) for a plan offering an employer match. Values can be entered on the plan analysis server system and method upload page by an app user. The values are downloaded as an array of “matchFormulas” from the plan data and passed to the plan analysis server system and method app via the web service. Each tier that is entered on the upload page would have a value to signify the maxPercent (Limit), percent (Match) and sequenceNumber (Tier) and is evaluated via the following formula:

“matchFormulas”: [{“maxPercent” “number”, “percent”: “number”, “sequenceNumber”: “number”,}]

where maxPercent is the limit percentage amount taken from the upload page, percent equals the match percentage amount taken from the upload page, and sequenceNumber equals the sequence number which correspond to the tiers of information entered on the upload page. The tiers can comprise “1” to identify Tier 1 percentages, “2” to identify Tier 2 percentages, and “3” to identify Tier 3 percentages (e.g., see match fields 130 in FIG. 1).

In some embodiments, the plan analysis server system and method can utilize a plan variable comprising a “Plan Auto-enroll Flag” variable defined as a “Yes” or “No” selection on plan analysis server system and method upload page to indicate if a plan offers auto-enrollment. The selection can be made by the plan analysis server system and method app user as defined earlier where an auto enrollment toggle 142 can be used to set and indicate automatic enrollment 140.

In some embodiments, the plan analysis server system and method can utilize a plan variable comprising a “Plan Auto-enroll Percent” variable defined as the beginning deferral percentage used for a plan offering auto-enrollment. In some embodiments, plan analysis server system and method can upload page as “Contribution Start Level” and entered by plan analysis server system and method app user (e.g., see contribution start level field 144 in FIG. 1).

In some embodiments, the plan analysis server system and method can utilize a plan variable comprising a “Plan Auto-escalate Flag” variable defined as a “Yes” or “No” selection on a plan analysis server system and method upload page that can indicate if a plan offers auto-escalation. Selection made by plan analysis server system and method app user (e.g., see automatic enrollment escalation 150, with escalation toggle 152).

In some embodiments, the plan analysis server system and method can utilize a plan variable comprising a “Plan Auto-escalate Percent” variable defined as the percentage by which employee deferrals will be increased for auto-escalation. This can be listed within a plan analysis server system and method upload page as “Annual increment” and entered by plan analysis server system and method app user (shown as percentage data field 154 in FIG. 1).

In some embodiments, the plan analysis server system and method can utilize a plan variable comprising a “Plan Auto-escalate Percent Max” variable defined as the percentage by which employee deferrals will be increased for auto-escalation. This can be listed by the plan analysis server system and method upload page as “Annual increment” and entered by plan analysis server system and method app user (shown as percentage data field 156 in FIG. 1).

In some embodiments, the plan analysis server system and method can utilize a plan variable comprising a “Annual Pay Periods” variable defined as the number of pay periods the employer has in a year. This can be listed on plan analysis server system and method upload page as “Pay periods in one year” and entered by plan analysis server system and method app user (shown as data field 158).

In some embodiments, the plan analysis server system and method can utilize a plan variable comprising a “Eligible Employees” variable defined as the total number of employee records included in plan data uploaded to the plan analysis server system and method.

In some embodiments, the plan analysis server system and method can utilize a plan variable comprising a “Average Account Balance” variable defined as the average retirement savings amount for all eligible employees. This can be calculated by totaling the asset size, then dividing by the total number of eligible employees.

In some embodiments, the plan analysis server system and method can utilize a plan variable comprising a “Average Deferral Percentage” variable defined as the average percentage of income that employees in the current plan are deferring. This can be calculated by adding the employee deferral percentage for all eligible employees, then dividing by the total number of eligible employees.

Some embodiments include employee variables. For example, in some embodiments, the plan analysis server system and method can utilize employee variables comprising the annual salary of an employee that can be provided to the plan analysis server system and method.

In some embodiments, the plan analysis server system and method can utilize a plan variable comprising a “Employee Age” variable defined as the calculated age of the employee from the plan data service. In some embodiments, the plan analysis server system and method calculates the age of the participant base on the date of upload and the date of birth, and calculates the age as a whole number. The age is a static point in time variable provided to the plan analysis server system and method, and it is not recalculated.

In some embodiments, the plan analysis server system and method can utilize a plan variable comprising a “Employee Deferral Percentage” variable defined as the percentage of an employee salary currently being deferred by an employee. In some embodiments, the plan analysis server system and method can utilize a plan variable comprising a “Employee Account Balance” variable defined as the current amount of retirement savings for an employee.

In some embodiments of the invention, participants can be excluded from data set for the following reasons for one or more reasons, including, but not limited to, missing employee date of birth, the employees salary is missing or zero in source data, or the salary is $220K or greater.

Some embodiments include certain flag rules for automatic enrollment and/or automatic escalation. In some embodiments, one or more lines of participant data can be assigned one or more flags that are independently identified. In some embodiments, the flags can be set for each participant based on the value in the deferral column. In some embodiments, the plan analysis server system and method can use one or more rules described below to apply flags appropriately. In some embodiments, the participant data can be passed through to the plan analysis server system and method application with flags already assigned.

In some embodiments, to apply the employee auto-enroll flag, the plan analysis server system and method can identify all eligible employees with a deferral greater than zero and set the employee auto-enroll flag to TRUE. The plan analysis server system and method can then identify the eligible employees with a deferral of zero, randomly select 90% of those employee, and set the employee auto-enroll flag to TRUE. Finally, the service can set the employee auto-enroll flag to FALSE for the remaining 10% of employees with a deferral of zero as identified in step two. This flag is independent of the employee auto-escalation flag and employee auto-enroll and escalate flag and is included in the calculation for at least one of the current participation rate, the current participation rate by age, the current participation rate by salary, the anticipated participation rate, the anticipated participation rate by age, the anticipated participation rate by salary, the change in employee enrollment, the current average deferral percentage, the current average deferral percentage by age, the current average deferral percentage by salary, the anticipated average deferral percentage, the anticipated average deferral percentage by age, the anticipated average deferral percentage by salary, the change in average deferral, the current average deferral percentage without match, the current average deferral percentage high compensated employee (hereinafter “hce”) cap without match, the current average deferral percentage with match, the current average deferral percentage hce cap with match, the anticipated average deferral percentage without match, the anticipated average deferral percentage hce cap without match, the anticipated average deferral percentage with match, the anticipated average deferral percentage hce cap with match, and the change in average employee savings with match contribution.

In some embodiments, to apply an employee auto-escalation flag, the plan analysis server system and method can identify eligible employees with a deferral greater than zero, randomly select 85% of those employees, and set the employee auto-escalation flag to TRUE. In some embodiments, the plan analysis server system and method can then set the employee auto-escalation flag to FALSE for the remaining 15% of employees identified in step one. Finally, the plan analysis server system and method can set the employee auto-escalation flag to FALSE for the eligible employees with a deferral of zero. The flag is independent of the employee auto-enroll flag and employee auto-enroll and escalate flag, and included in the calculations for at least one of current average deferral percentage in 1 year, current average deferral percentage in 2 years, current average deferral percentage in 3 years, anticipated average deferral percentage in 1 year, anticipated average deferral percentage in 2 years, anticipated average deferral percentage in 3 years, and change in average deferral in 3 years.

In some embodiments, to apply the employee auto-enroll and escalate flag, the plan analysis server system and method can identify all eligible employees with a deferral greater than zero. The plan analysis server system and method can then identify the eligible employees with a deferral of zero and randomly selects 90% of those employees. The plan analysis server system and method can then combine all eligible employees in step one and step two into one list. Next, using the newly created list, the plan analysis server system and method can randomly select 85% and set the employee auto-enroll and escalate flag to true. Then, the plan analysis server system and method can set the employee auto-enroll and escalate flag to FALSE for the remaining 10% of employees from step three. Finally, the plan analysis server system and method can set the employee auto-enroll and escalate flag to FALSE for the remaining 15% of employees from step four.

In some embodiments, the flag can be independent of the employee auto-enroll flag and auto escalate flag, and included in the calculations for at least one of the current participation rate, the current participation rate by age, the current participation rate by salary, the anticipated participation rate, the anticipated participation rate by age, the anticipated participation rate by salary, the change in employee enrollment, the current average deferral percentage, the current average deferral percentage by age, the current average deferral percentage by salary, the anticipated average deferral percentage, the anticipated average deferral percentage by age, the anticipated average deferral percentage by salary, the change in average deferral, the current average deferral percentage in 1 year, the current average deferral percentage in 2 years, the current average deferral percentage in 3 years, the anticipated average deferral percentage in 1 year, the anticipated average deferral percentage in 2 years, the anticipated average deferral percentage in 3 years, the change in average deferral in 3 years, the current average deferral percentage without match, the current average deferral percentage hce cap without match, the current average deferral percentage with match, the current average deferral percentage hce cap with match, the anticipated average deferral percentage without match, the anticipated average deferral percentage hce cap without match, the anticipated average deferral percentage with match, the anticipated average deferral percentage hce cap with match, the change in average employee savings with match contribution.

The following describes non-limiting examples of calculations performed by the plan analysis server system and method using an example embodiment of 100 eligible employees with 40 employees deferring greater than 0%. For example, as a non-limiting auto enrollment flag embodiment, for all 40 eligible employees deferring, a server of the plan analysis server system and method can set auto enroll flag to TRUE, and for 60 eligible employees not deferring, the server selects a random 90% (54) of 60 Eligible Employees not deferring and sets the Auto Enroll flag to TRUE. The plan analysis server system and method server can set the auto enroll flag on the remaining random 10% (6) of 60 eligible employees not deferring to FALSE. Further, for a non-limiting auto escalate flag, for the 40 eligible employees who are deferring, the plan analysis server system and method server can select a random 85% (34) of these 40 eligible employees who are deferring, and set the auto escalate flag to true for remaining random 15% (6) of these 40 eligible employees who are deferring. The plan analysis server system and method server can then set the auto escalate flag to FALSE for 60 eligible employees who are not deferring, and set the auto escalate flag to FALSE. Further, for an auto enroll/auto escalate flag, with all 40 Eligible Employees deferring, the plan analysis server system and method server can identify these 40 eligible employees (no flags are set at this point). For the 60 eligible employees not deferring, the server can identify a random 90% of these 60 (54) eligible employees who are not deferring (no flags are set at this point). The plan analysis server system and method server can then combine the two groups above (94) and set the auto enroll/auto escalate flag to TRUE for a random 85% of these eligible employees (80). The plan analysis server system and method server can then set the auto enroll/auto escalate flag to FALSE for the remaining random 10% (6) of non-deferring eligible employees from step 2 above. The auto enroll/auto escalate flag is set to FALSE for the remaining 15% (14) of the eligible employees from step 3 above.

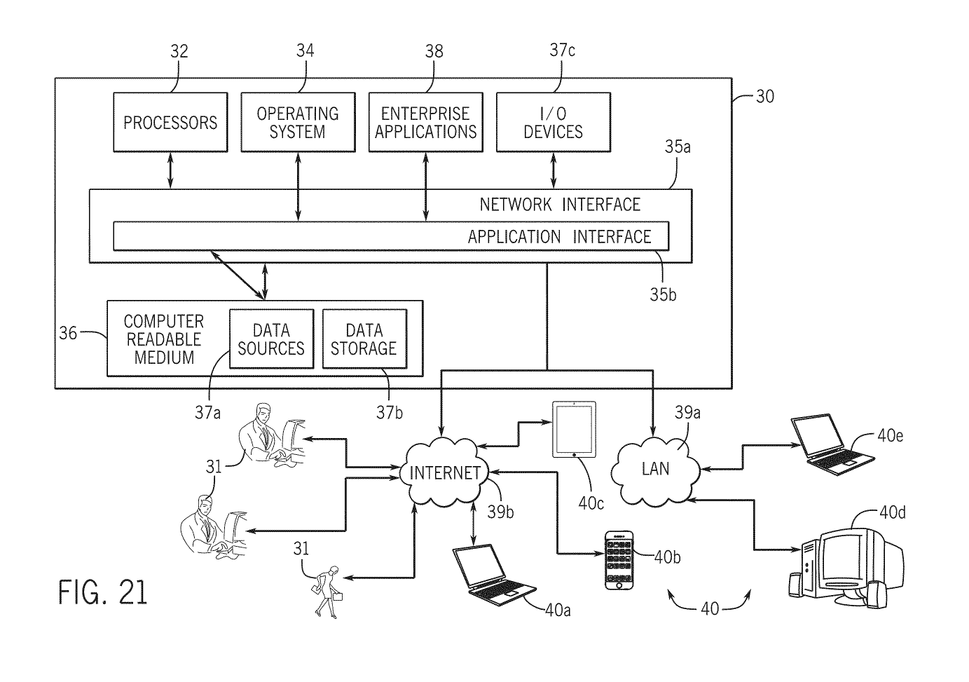

FIG. 21 shows one example of a system architecture 30 implementation of the plan analysis server system and method according to one embodiment of the invention. As shown, the system 30 can include at least one computing device, including at least one or more processors 32. Some processors 32 can include processors 32 residing in one or more server platforms. The plan analysis server system and method architecture 30 can include a network and application interface 35 coupled to a plurality of processors 32 running at least one operating system 34, coupled to at least one data storage device 37b, a plurality of data sources 37a, and at least one input/output device 37c. Some embodiments include at least one computer readable medium 36. For example, in some embodiments, the invention can also be embodied as computer readable code on a non-transitory computer readable medium 36. The computer readable medium 36 can be any data storage device that can store data, which can thereafter be read by a computer system. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium 36 can also be distributed over a network so that the computer readable code can be stored and executed in a distributed fashion. For example, in some embodiments, one or more components of the system architecture 30 can be tethered to send and/or receive data through a local area network (LAN) 39a. In some further embodiments, one or more components of the system architecture 30 can be tethered to send or receive data through an internet 39b. In some embodiments, modules 10, including enterprise applications 38, and one or more components of the system architecture 30 can be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device. Also, in some embodiments, the network 39a, 39b can include wide area networks (WAN's), direct connections, such as through a universal serial bus (USB) port, other forms of computer-readable media, or any combination thereof. Also, various other forms of computer-readable media 36 can transmit or carry instructions to a computer, including a router, private or public network, or other transmission device or channel, both wired and wireless. In some embodiments, one or more components of the network 39a, 39b can include a number of client devices which can be personal computers, digital assistants, personal digital assistants, cellular phones, mobile phones, smart phones, pagers, digital tablets, laptop computers, Internet appliances, and other processor-based devices. In general, a client device can be any type of external or internal devices such as a mouse, a CD-ROM, DVD, a keyboard, a display, or other input or output devices.

In some embodiments, the system architecture 30 as described can enable one or more users 40 to receive, analyze, input, modify, create and send data to the system architecture 30, including to and from one or more enterprise applications 38 running on the system architecture 30. Some embodiments include at least one user 40 accessing one or more modules 10, including at least one enterprise applications 38 via a stationary I/O device 37c through a LAN 39a. In some other embodiments, the system architecture 30 can enable at least one user 40 accessing one or more modules 10, including at least one enterprise application 38 via a stationary or mobile I/O device 37c through an internet 39a. In some embodiments, the plan analysis server system and method modules 10 can be configured as a plan analysis server system and method 20 using at least the system architecture 30 depicted in FIG. 21. Furthermore, in some embodiments, one or more of the modules 10 can be further configured to enable one or more users 40 to select or define one or more of the modules 10, or to interface with a plurality of other programs or data sources in a seamless manner.

In some embodiments of the plan analysis server system and method can include methods to display and present data to a user, including for instance, a graphical user interface (hereinafter referred to as “GUI”). In some embodiments, the GUI can be rendered on any user device that includes a display screen, including, but limited to a computer display (such as a terminal or monitor), a television, a projection display, or a mobile device such as a laptop, tablet, phone or PDA, or other mobile computer system. In some other embodiments, the GUI can be rendered onto any surface capable of being viewed by a user (for example, a screen or wall used as a projection surface). In some embodiments, the user can interact with the system using any computer peripheral known in the art, including, but not limited to, a keyboard, a mouse, a pen-input device, a touch screen, a haptics device, a gesture device, or a voice-activated function hardware and/or software solution. In some embodiments, the user can be provided with any option to modify the format of the GUI display, for example, to add or remove various functional components, or change the overall look and feel of the GUI display.

The above-described databases and models throughout plan analysis server system and method architecture 30 can store analytical models and other data on computer-readable storage media 36, 37a, 37b. In addition, the above-described applications of the system architecture 30 can be stored on computer-readable storage media 36, 37a,37b. In some embodiments, the plan analysis server system and method can comprise one or more components or functions of the back office server infrastructure 2010 and/or the Tablet optimized flow 2060. In some other embodiments, the plan analysis server system and method can be coupled with the Tablet optimized flow 2060 and/or the back office server infrastructure 2010 to enable calculation and processing of data and/or exchange of data between the Tablet optimized flow 2060 and the back office server infrastructure 2010.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The processes and method steps performed within the plan analysis server system and method cannot be performed in the human mind or derived by a human using pen and paper, but require machine operations to process input data to useful output data. The processes and method steps performed within the plan analysis server system and method by the architecture 30 include a computer-implemented method comprising steps performed by at least one processor.

The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, are intended to be encompassed by the invention.

1. An plan analysis server system comprising:
at least one computing device comprising at least one processor;
a non-transitory computer readable medium, having stored thereon, instructions that when executed by the at least one computing device, cause the at least one computing device to perform operations comprising:
coupling to a back-end database server comprising current plan data;
calculating an eligible employee total by counting the number of employees records in the current plan data;
totaling a plan asset size by summing account balances for all eligible employees;
determining employees with non-zero deferral from the current plan data,
calculating a current participation rate by calculating the percentage of eligible employees with non-zero deferral;
processing and displaying at least one current plan utilizing eligible employee data and administrator input, the at least one current plan displayed in a primary window as selected by the user from user input, the display optionally including at least one of an average account balance, a current participation rate, an average deferral percentage, and an average matching percentage, wherein the at least one processor calculates the average account balance by dividing the total number of eligible employees by the current participation rate, and wherein the at least one processor calculates the average deferral percentage by accessing the plan records of all eligible employees and calculating the average percentage of income that employees in the current plan are deferring by summing the deferrals of all eligible employees and dividing by the total number of eligible employees, and wherein the at least one processor calculates the average matching percentage by base on one or more tier match percentages and tier limits; and
optionally processing at least one scenario display utilizing the eligible employee data and administrator input, the at least one scenario display being displayed as one or more layers on the current plan data and displayed in the primary window as selected by the user from the user input,
the scenario display optionally including at least one of the average account balance, the current participation rate, the average deferral percentage, and the average matching percentage, wherein the average account balance, the current participation rate, the average deferral percentage, and the average matching percentage can deviate from the current plan based on user input.

2. The system of claim 1, where the average matching percentage is calculating by multiplying a tier 1 match percentage by the smaller of either the employee deferral percentage or a tier 1 limit; and
wherein if there is a tier 2 match, the at least one processor multiplies the tier 2 match percentage by the smaller of either the remaining employee deferral percentage or the tier 2 limit, and adds the value to the tier 1 matching percentage; and
wherein if there is a tier 3 match, the at least one processor multiplies the tier 3 match percentage by the smaller of either the remaining employee deferral percentage or the tier 3 limit, and adds the value to the tier 2 matching percentage, and calculates the average by summing a matching percentage payable to all eligible employees and dividing the value by the total number of eligible employees.

3. The system of claim 1, wherein any one of the average account balance, a current participation rate, an average deferral percentage, and an average matching percentage can be displayed in a secondary window at least partially overlapping the primary window.

4. The system of claim 2, wherein at least one of the brightness, contrast, and color of at least a portion of the primary window can be at least partially darkened when the secondary window is displayed over the primary window.

5. The system of claim 1, wherein the percentage of eligible employees is displayed in at least one bar chart,

6. The system of claim 5, wherein the at least one bar chart comprises eligible employees as a function of age or age range.

7. The system of claim 5, wherein the at least one bar chart comprises eligible employees as a function of salary or salary range.

8. The system of claim 1, wherein the average employee contribution is displayed in at least one bar chart.

9. The system of claim 8, wherein the at least one bar chart comprises average employee contribution as a function of age or age range.

10. The system of claim 1, wherein the at least one bar chart comprises average employee contribution as a function of salary or salary range.

11. The system of claim 1, wherein the user input is selectable or entered on the scenario display and includes at least one of an employee contribution auto-enrollment entry option, an employee contribution auto-escalate entry option, and a matching contribution value entry option.

12. The system of claim 11, wherein upon a user input to any one of the employee contribution auto-enrollment entry option, an employee contribution auto-escalate entry option, or matching contribution value entry option, the at least one processor dynamically updates the scenarios display.
